(19) United States
(12) Patent Application Publication
(10) Pub. No.: US 2024/0128482 A1
(43) Pub. Date: Apr. 18, 2024

(54) SYSTEMS AND METHODS FOR OPTIMIZING AN EJECTOR DESIGN TO INCREASE OPERATING RANGE

(71) Applicants: CUMMINS INC., Columbus, IN (US); HYDROGENICS CORPORATION, Mississauga (CA)

(72) Inventors: Richard J. ANCIMER, Toronto (CA); Eero Andresson Aherma TEENE, Hamilton (CA); Paolo FORTE, Maple (CA); Sumit TRIPATHI, Columbus, IN (US)

(21) Appl. No.: 18/390,113

(22) Filed: Dec. 20, 2023

Related U.S. Application Data
(63) Continuation of application No. PCT/US2022/034526, filed on Jun. 22, 2022.
Application No. PCT/US2022/034526 is a continuation of application No. PCT/US2022/034530, filed on Jun. 22, 2022.
Application No. PCT/US2022/034530 is a continuation of application No. PCT/US2022/034524, filed on Jun. 22, 2022.
(60) Provisional application No. 63/215,096, filed on Jun. 25, 2021.
(60) Provisional application No. 63/215,083, filed on Jun. 25, 2021.
(60) Provisional application No. 63/215,091, filed on Jun. 25, 2021.

(51) Int. Cl. H01M 8/04089; B01F 23/10; B01F 25/312; H01M 8/04119; H01M 8/04746

(52) U.S. Cl. CPC H01M 8/04097; B01F 23/10; B01F 25/31251; B01F 25/31252; B01F 25/312533; H01M 8/04179; H01M 8/04753; B01F 2101/59

(57) ABSTRACT

The present disclosure is generally directed to a design geometry of a venturi or an ejector that is optimized in systems and methods for increasing the operating range of the venturi or the ejector in a fuel cell system. The present disclosure is also generally directed to fuel cell systems and methods for sizing and/or integrating a recirculation blower with a venturi or an ejector in a fuel cell or fuel cell stack. The present disclosure is further generally directed to systems and methods of operating a fuel cell system comprising more than one venturi or ejectors during transient operations.

### CROSS-REFERENCE TO RELATED APPLICATIONS

This application is a continuation of, claims priority to, and the benefit of, under 35 U.S.C. § 111(a), International PCT Patent Application No. 2022/034526 filed on Jun. 22, 2022, which claims the benefit and priority, under 35 U.S.C. § 119(e) and any other applicable laws or statutes, to U.S. Provisional Patent Application Ser. No. 63/215,096 filed on Jun. 25, 2021; this application is also a continuation of, claims priority to, and the benefit of, under 35 U.S.C. § 111(a), International PCT Patent Application No. 2022/034530 filed on Jun. 22, 2022, which claims the benefit and priority, under 35 U.S.C. § 119(e) and any other applicable laws or statutes, to U.S. Provisional Patent Application Ser. No. 63/215,083 filed on Jun. 25, 2021; and this application is further a continuation of, claims priority to, and the benefit of, under 35 U.S.C. § 111(a), International PCT Patent Application No. 2022/034524 filed on Jun. 22, 2022, which claims the benefit and priority, under 35 U.S.C. § 119(e) and any other applicable laws or statutes, to U.S. Provisional Patent Application Ser. No. 63/215,091 filed on Jun. 25, 2021, the entire disclosures of all of which are hereby expressly incorporated herein by reference.

### TECHNICAL FIELD

The present disclosure relates to systems and methods of optimizing the geometry of a venturi or an ejector to increase its operating range in a fuel cell, fuel cell stack, and/or fuel cell system. The present disclosure also relates to fuel cell systems and methods for sizing and/or integrating a recirculation blower with a venturi or an ejector. The present disclosure further relates to systems and methods of operating a system comprising more than one venturi or ejector in fuel cell, fuel cell stack, and/or fuel cell system during transient operations.

### BACKGROUND

Vehicles and/or powertrains use fuel cells, fuel cell stacks, and/or fuel cell systems for their power needs. A minimum excess fuel target for a fuel cell system may be specified as a minimum level of an excess fuel target required by the fuel cell or fuel cell stack based on the operating conditions of the fuel cell, stack, or system. A fuel cell or fuel cell stack may have an excess fuel level higher than the minimum excess fuel target, but achieving that higher level may result in a high parasitic load on the fuel cell or fuel cell stack. For example, the excess fuel level higher than the minimum excess fuel target may be achieved by maintaining high fuel flow rates at the anode, which may lead to a pressure loss in the fuel cell, stack, or system.

A blower and/or a pump (e.g., a recirculation pump) may function at a capacity proportional to the pressure loss in the fuel cell or fuel cell stack. The blower and/or the pump may also function at a capacity proportional to a volumetric flow rate through the blower and/or the pump. A blower and/or a pump may use additional power to compensate for the pressure loss. However, use of additional power by the blower and/or the pump may result in a high parasitic load on the fuel cell, fuel cell stack, and/or fuel cell system.

Geometric design of a venturi or a ejector is critical to its performance and/or operation in a fuel cell system since the fuel circulated by the blower and/or pump enters the ejector as secondary flow. While several methods have been adapted to determine different geometric parameters required for optimal performance of the venturi or ejector in a fuel cell system, there remain several limitations. For example, many methods effectively allow for higher primary pressures and mask limitations of the venturi or ejector at low operating current densities. In addition, many methods do not account for limits associated with thermodynamics and how the thermodynamic limits interact with the required venturi or ejector efficiency of the system.

Thermodynamic availability considerations are not currently considered in design and/or optimization of the venturi or ejector performance across the fuel cell system. In particular, noise factors in the fuel cell system are not typically considered during venturi or ejector design. Factors such as primary fuel temperature, transient operation conditions, system purge flow requirements, any build-up of contaminants in the anode gas recirculation loop of the fuel cell system are not currently considered. Further, many methods do not take into account that at low operating points, the venturi or ejector tends to operate when neither the primary nozzle nor the secondary flow are choked.

The present disclosure relates to systems and methods of optimizing the geometric design of an venturi or an ejector to overcome high costs and parasitic loads associated with the recirculation pump or blower in the fuel cell system while meeting the excess fuel ratio requirements. The present disclosure also relates to systems and methods for extending the operating range of the venturi or ejector by appropriate design of geometric parameters that balances highest current density operating point and lowest current density operating point requirements of the system.

The present disclosure also related to systems and methods for operating and/or integrating a fuel cell system to enable the blower or pump to boost ejector performance, optimally sizing the blower or pump based on ejector performance and/or system transient state, and optimally using one or more by-pass valve(s) based on system requirements.

A blower and/or pump (e.g., a recirculation pump) may function at a capacity proportional to the pressure loss in the fuel cell or fuel cell stack, and thus use additional power to compensate for the pressure loss. Use of additional power by the blower and/or the pump may result in a high parasitic load on the fuel cell, fuel cell stack, and/or fuel cell system. Different system configurations may be implemented such that the fuel cell stack system may deliver the required entrainment ratio and/or power with a minimum parasitic load. The present disclosure further relates to systems and methods for using, sizing, determining, and/or implementing more than one venturi or ejector in a series or in a parallel configuration in a fuel cell system that may be operating in a transient state or under transient conditions.

### SUMMARY

Embodiments of the present disclosure are included to meet these and other needs.

In one aspect of the present disclosure, described herein, a fuel cell or fuel cell system includes an ejector, a first fuel, and a second fuel. The ejector includes a primary nozzle, a mixer, a mixer entrance, a mixer inlet area, a mixer length, a mixer diameter, a mixer outlet area, a diffuser, and a diffuser outlet area. The primary nozzle includes a primary nozzle throat diameter, a primary nozzle inlet area, and a primary nozzle throat area. The first fuel is from a fuel supply that flows through the primary nozzle into the mixer. The second fuel flows through an anode recirculation loop which includes a secondary suction chamber into the mixer. The ejector is sized based on a lower current density operating point or a highest current density operating point of the fuel cell system.

In some embodiments, the ejector may include a mixer area ratio (MAR) sized for the highest current density operating point. The MAR may allow about 2 to about 20 times the amount of the second fuel to enter the ejector at the lowest current density operating point compared to the amount of the second fuel that enters the ejector at the highest current density operating point. In some embodiments, the MAR may be optimized to allow a required entrainment ratio at the highest current density operating point.

In some embodiments, the ejector may include other geometry parameters optimized at the lowest current density operating point. The other geometry parameters may be a ratio of the mixer length to the mixer diameter (MLR), a diffuser diverging angle, or a ratio of the diffuser outlet area to the mixer outlet area (DAM). In some embodiments, the ratio of the mixer length to the mixer diameter (MLR) may be from about 3 to about 7. In some embodiments, the ratio of the diffuser outlet area to the mixer outlet area (DAM) may be from about 1.9 to about 7.3. In some embodiments, the diffuser diverging angle may be from about 6° to about 18°.

In some embodiments, the mixer area ratio (MAR) of the ejector may allow a minimum target excess fuel ratio (λ_TRGT) to be achieved at the highest operating current density of the system.

In some embodiments, the suction chamber may include a nozzle to mixer inlet distance (N2M) and a converging angle at mixer inlet (a E s) that minimizes losses through the suction chamber at the highest current density operating point. In some embodiments, the nozzle to mixer inlet distance (N2M) may be optimized at the lowest current density operating point. The ratio of the nozzle to mixer inlet distance (N2M) to the primary nozzle throat diameter may be about 0 to about 5.

In some embodiments, the velocity of the second fuel may include a Mach number below about 0.2 at the exit plane of the primary nozzle.

In some embodiments, the ejector may include a geometric configuration optimized to operate at the lowest current density and the highest current density.

In some embodiments, the fuel cell system may include a purge valve and the primary nozzle may be sized based on a purge flow required by the fuel cell system. In some embodiments, the primary nozzle may be sized based on a maximum instantaneous purge at the highest current density.

In some embodiments, the system may include a mixer area a mixer area ratio (MAR) of about 4 to about 5.2 for a primary inlet pressure (P_{O}) of about 5.7 bara at a maximum current flow rate with a primary inlet manifold pressure (P_{AIM}) of about 2.5 bara, a target entrainment ratio (ER) of about 1.6, a suction chamber efficiency of about 65% to about 50%, and a pressure lift (ΔP_{LIFT}) of about 5 kPa to 25 kPa. In some embodiments, if the system includes a contaminant level of about 4% to about 8% in the anode recirculation loop, the mixer area ratio (MAR) may be about 4.5 to about 5.7.

In a second aspect of the present disclosure, a method of purging and managing pressure in a fuel cell system includes the steps of flowing a first fuel at a first mass flow rate from a fuel supply through a primary nozzle into a mixer region, flowing a second fuel through an anode recirculation loop including a secondary suction chamber into the mixer region, mixing the first fuel and the second fuel to form a mixture in a mixer including a diffuser, flowing the mixture through a fuel cell stack, purging a part of the mixture through a purge valve, and managing pressure of an anode side volume of the fuel cell stack system during purging. The fuel supply includes a fuel supply pressure and a fuel supply temperature. The ejector includes a mixer area ratio (MAR) and a mixer length ratio (MLR). The primary nozzle is sized based on the fuel supply pressure, the fuel supply temperature, and a highest fuel flow rate required by the fuel cell system.

In some embodiments, the purge valve may be opened for 0 seconds periodically every T seconds. θ/T may be high enough to remove any contaminants accumulating in the system.

In some embodiments, pressure of the anode side volume of the fuel cell system may be decreased at a rate (β) based on purge volumetric flow rate, the anode side volume, and stack pressure.

In some embodiments, managing pressure of anode side volume of the fuel cell system during purging may include increasing the first mass flow rate of the first fuel to offset any decrease in the pressure of the anode side volume of the fuel cell system.

In one aspect of the present disclosure, described herein, a system for monitoring or controlling operation of a fuel cell system includes a first fuel entering an ejector, a second fuel entering a blower or the ejector, and a controller that communicates with the blower or the ejector to monitor or control flow of the first fuel or the second fuel in the fuel cell system. The ejector has a primary inlet pressure and a secondary inlet pressure.

In some embodiments, the fuel cell system may operate in a system operating state including a steady state or a transient state. The fuel cell system may include a target excess fuel ratio or an anode gas inlet humidity. In some embodiments, the blower may operate in a blower operating state including idle state, ejector support state, or prime state. The controller may determine the blower operating state. In some embodiments, a by-pass valve may be positioned across the blower to allow the second fuel to flow around the blower. In some embodiments, the controller may communicate with the by-pass valve positioned across the blower. In some embodiments, the controller may determine a pressure drop at the system operating state, a pressure lift that can be delivered by the ejector, and may determine if the pressure drop is greater or lesser than the pressure lift that can be delivered by the ejector.

In some embodiments, if the pressure drop is less than the pressure lift that can be delivered by the ejector, the blower may operate in the idle state. In some embodiments, if the pressure drop is less than the pressure lift that can be delivered by the ejector, the by-pass valve positioned across the blower may be opened. In some embodiments, if the pressure drop is more than the pressure lift that can be delivered by the ejector, the blower may operate in the ejector support state.

In some embodiments, the controller may determine a blower operating state based on a target entrainment ratio of the fuel cell system, efficiency of the blower, choked or unchoked condition of the ejector, or transient or steady state of the fuel cell system.

In a second aspect of the present disclosure, a method for monitoring or controlling operation of a fuel cell system includes the steps of flowing a first fuel into an ejector, flowing a second fuel into a blower or the ejector, communicating with the blower or the ejector through a controller, and monitoring or controlling flow of the first fuel or flow of the second fuel in the fuel cell system. The ejector has a primary inlet pressure and a secondary inlet pressure.

In some embodiments, the method may include operating the fuel cell system in a system operating state including a steady state or a transient state. The fuel cell system may include a target excess fuel ratio or an anode gas inlet humidity. In some embodiments, the method may further include the blower operating in a blower operating state including idle state, ejector support state, or prime state. In some embodiments, the fuel cell system may include a by-pass valve positioned across the blower to allow the second fuel to flow around the blower. In some embodiments, the method may include the controller communicating with the by-pass valve positioned across blower. In some embodiments, the method may further include the controller determining the blower operating state. In some embodiments, the method may further include the controller determining a pressure drop at the system operating state, a pressure lift that can be delivered by the ejector, and may determine if the pressure drop is greater or lesser than the pressure lift that can be delivered by the ejector.

In some embodiments, if the pressure drop is less than the pressure lift that can be delivered by the ejector, the method may include the controller operating the blower in the idle state. In some embodiments, if the pressure drop is less than the pressure lift that can be delivered by the ejector, the method may further include opening the by-pass valve positioned across the blower. In some embodiments, if the pressure drop is more than the pressure lift that can be delivered by the ejector, the method may further include operating the blower in the ejector support state.

In one aspect of the present disclosure, described herein, a fuel system includes a first ejector, a second ejector, an energy storage device, and an integrated controller. The integrated controller communicates with the energy storage device, the first ejector, and the second ejectors. The first ejector includes a first primary fuel, a first entrained fuel, a first maximum current density, and a first minimum current density. The second ejector includes a second primary fuel, a second entrained fuel, a second maximum current density, and a second minimum current density. The fuel cell system operates in a transient lag state.

In some embodiments, the fuel cell system may further include a blower in a series or parallel configuration with the first ejector or with the second ejector.

In some embodiments, the first ejector may be in a parallel configuration or in a series configuration with the second ejector. In some embodiments, the fuel cell system may transition between operating a solo configuration and operating in a dual configuration based on operating pressure. Operating in the solo configuration may include operating the first ejector or the second ejector, while operating in the dual configuration includes operating the first ejector and the second ejector.

In some embodiments, the fuel cell system may transition between operating in a solo configuration and operating in a dual configuration based on storage capacity of the energy storage device. Operating in the solo configuration may include operating the first ejector or the second ejector, while operating in the dual configuration may include operating the first ejector and the second ejector. In some embodiments, the integrated controller may determine a sufficient energy available in the energy storage device such that an anode pressure during transient lag state reaches a nominal anode pressure.

In some embodiments, the fuel cell system may include a required entrainment ratio. The energy storage device may power the fuel cell system to achieve the required entrainment ratio if the first ejector or the second ejector cannot provide the required entrainment ratio. In some embodiments, the fuel cell system may include a third ejector in a series or in a parallel configuration with the first ejector or with the second ejector.

In some embodiments, the energy storage device may be a battery. In some embodiments, the energy storage device may include a supercapacitor, a superconductor, a flywheel, compressed air, or a phase change material.

In a second aspect of the present disclosure, a method of operating a fuel cell system includes the steps of flowing a first primary fuel through a control valve and through a first ejector, flowing a first entrained fuel through the first ejector, flowing a second primary fuel through the control valve and through a second ejector, flowing a second entrained fuel through the second ejector, and operating the first ejector or the second ejector in a transient lag state.

In some embodiments, the first ejector may be in a parallel configuration or in a series configuration with the second ejector. In some embodiments, the method may further include using an energy storage device. In some embodiments, operating the fuel cell system may include transitioning between operating in a solo configuration including the first ejector or the second ejector and operating in a dual configuration including the first ejector and the second ejector. This transitioning may be based on a storage capacity of the energy storage device.

In some embodiments, using the energy storage device may include using an integrated controller that communicates with the energy storage device, the first ejector, and the second ejector. In some embodiments, the method may include the integrated controller determining a sufficient storage in the energy storage device such that an anode pressure of the fuel cell system during transient lag state reaches a nominal anode pressure. In some embodiments, the fuel cell system may transition between operating in a solo configuration including the first ejector or the second ejector and a dual configuration including the first ejector and the second ejector. This transitioning may be based on an operating pressure during transient lag state.

In some embodiments, the fuel cell system may include a required entrainment ratio. The method may include the energy storage device powering the fuel cell system to achieve the required entrainment ratio if the first ejector or the second ejector cannot provide the required entrainment ratio. In some embodiments, the energy storage device may be a battery. In some embodiments, the fuel cell system may include a third ejector in a series or in a parallel configuration with the first ejector or with the second ejector.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is an illustration of a fuel cell system including one or more fuel cell stacks connected to a balance of plant;

FIG. 1B is an illustration of a fuel cell system having fuel cell modules, each fuel cell module having fuel cell stacks and/or fuel cells;

FIG. 1C is an illustration of components of a fuel cell in the fuel cell stack;

FIG. 2 is a graph showing the operating curves of a system comprising a fuel cell or fuel cell stack;

FIG. 3 is a schematic showing a mechanical regulator used along with a venturi or an ejector in a fuel cell system;

FIG. 4 is a schematic showing a proportional control valve used along with a venturi or an ejector in a fuel cell system;

FIG. 5A is a graph showing the operating curves of a system comprising a venturi or an ejector under choked conditions;

FIG. 5B is a graph showing the operating curves of as system comprising a venturi or an ejector under choked and unchoked conditions;

FIG. 6 is a schematic showing the different regions in a mixer;

FIG. 7 is a schematic showing geometric parameters governing venturi or ejector design;

FIG. 8 is a graph showing the operating curves of a system comprising a blower in different operating states when the system is in a transient state;

FIG. 9 is a schematic showing by-pass valves across a blower and/or venturi or an ejector in a fuel cell system;

FIG. 10 is a block diagram showing one embodiment of a controller in communication with various components of a fuel cell stack system for monitoring and controlling the various components of the fuel cell stack;

FIG. 11A is a schematic showing one embodiment of a fuel cell system comprising multiple venturi or an ejector in a parallel configuration;

FIG. 11B is a schematic showing a second embodiment of a fuel cell system comprising multiple venturi or an ejector in a parallel configuration;

FIG. 12A is a schematic showing one embodiment of a fuel cell system comprising multiple venturi or an ejector in a series configuration;

FIG. 12B is a schematic showing a second embodiment of a fuel cell system comprising multiple venturi or an ejector in a series configuration;

FIG. 13A is a graph showing the division of labor between multiple ejectors when fuel supply pressure is about 14 bara; and

FIG. 13B is a graph showing the division of labor between multiple ejectors under transient state or conditions when fuel supply pressure is about 14 bara.

### DETAILED DESCRIPTION

The present disclosure relates to systems and methods for optimizing a geometric design of a venturi and/or an ejector in a fuel cell, fuel cell stack, and/or fuel cell system. More specifically, this disclosure relates to systems and methods for optimizing and/or balancing fuel supply limits and ranges with operating requirements of the fuel cell, stack, or system by optimizing geometric parameters of the venturi or the ejector.

The present disclosure also relates to fuel cell systems and methods for sizing and/or integrating a recirculation blower and/or pump with an ejector in a fuel cell system. The present disclosure describes different system operating states such as idle state, boosted by a blower in an ejector support state, prime state, and load shedding state. The present disclosure also relates to methods of operating and/or integrating a system to enable blower to boost ejector performance, optimally sizing the blower based on ejector performance and/or system transient state, and optimally using one or more by-pass valve(s) around the blower based on the fuel cell system requirement.

The present disclosure further relates to systems and methods of using, sizing, implementing, and/or determining the division of labor between more than one venturi or ejectors in a fuel cell system operating in a transient state or under transient conditions. The more than one venturi or ejectors may be in a series or parallel configuration. The present disclosure also relates to systems and methods of addressing any operating gaps when the fuel cell system during operation in a transient state or under transient conditions.

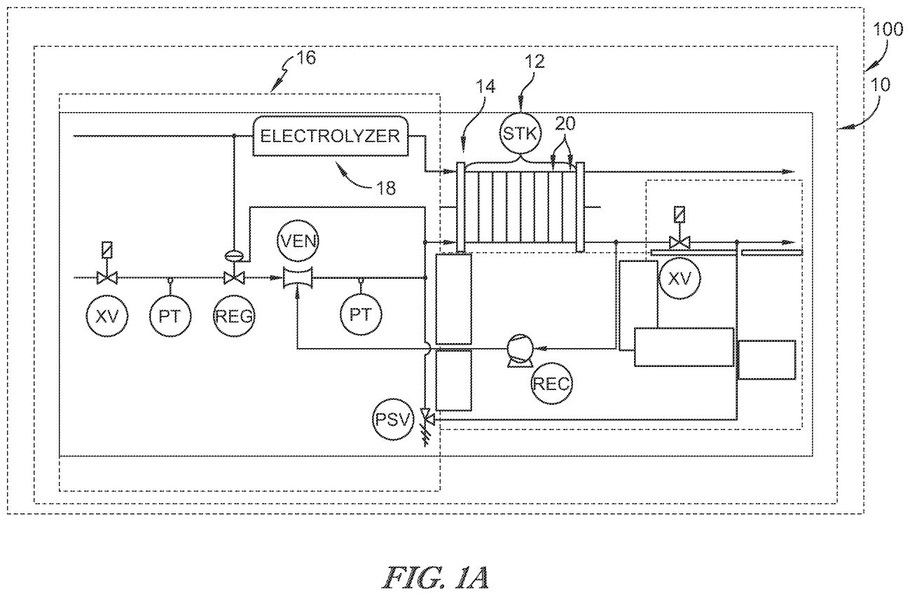

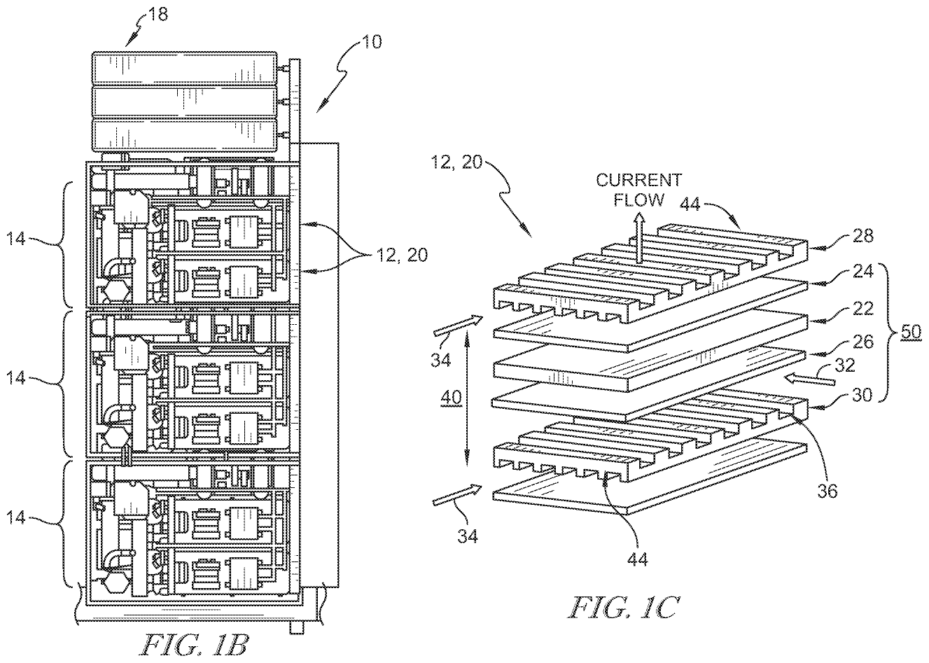

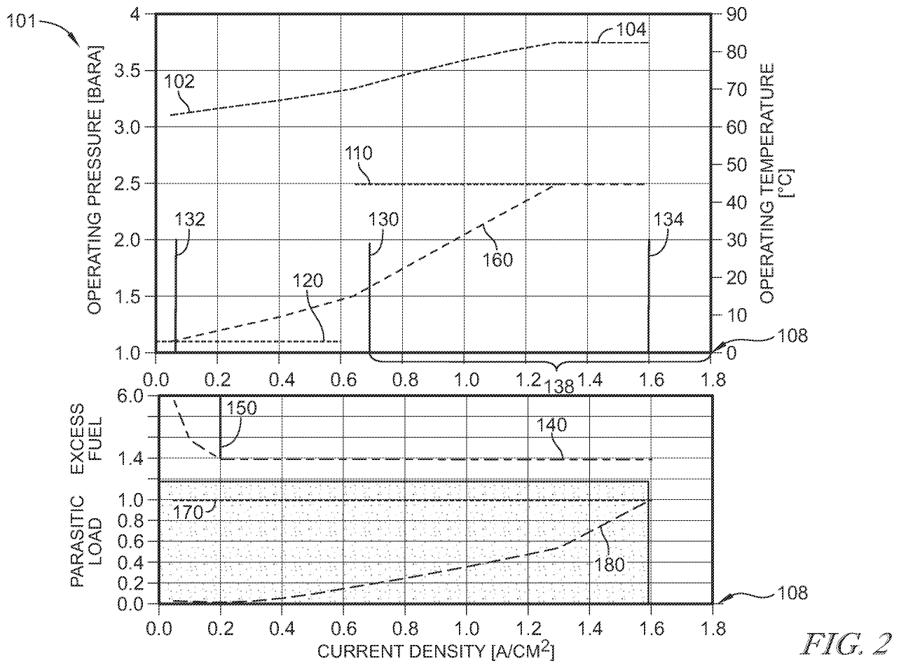

As shown in FIG. 1A, fuel cell systems 10 often include one or more fuel cell stacks 12 or fuel cell modules 14 connected to a balance of plant (BOP) 16, including various components, to create, generate, and/or distribute electrical power for meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 connected together in series and/or in parallel. The fuel cell system 10 may include one or more fuel cell modules 14 as shown in FIGS. 1A and 1B. Each fuel cell module 14 may include a plurality of fuel cell stacks 12 and/or a plurality of fuel cells 20.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26. The above mentioned components, 22, 24, 26, 30 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plate (BPP) 28, 30 can uniformly distribute reactants 32, 34 to an active area 40 of each fuel cell 20 through oxidant flow fields 42 and/or fuel flow fields 44. The active area 40, where the electrochemical reactions occur to generate electrical power produced by the fuel cell 20, is centered within the gas diffusion layer (GDL) 24, 26 and the bipolar plate (BPP) 28, 30 at the membrane electrode assembly (MEA) 22. The bipolar plate (BPP) 28, 30 are compressed together to isolate and/or seal one or more reactants 32 within their respective pathways, channels, and/or flow fields 42, 44 to maintain electrical conductivity, which is required for robust during fuel cell 20 operation.

The fuel cell system 10 described herein, may be used in stationary and/or immovable power system, such as industrial applications and power generation plants. The fuel cell system 10 may also be implemented in conjunction with electrolyzers 18 and/or other electrolysis system 18. In one embodiment, the fuel cell system 10 is connected and/or attached in series or parallel to an electrolysis system 18, such as one or more electrolyzers 18 in the BOP 16. In another embodiment, the fuel cell system 10 is not connected and/or attached in series or parallel to an electrolysis system 18, such as one or more electrolyzers 18 in the BOP 16.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy duty vehicle.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

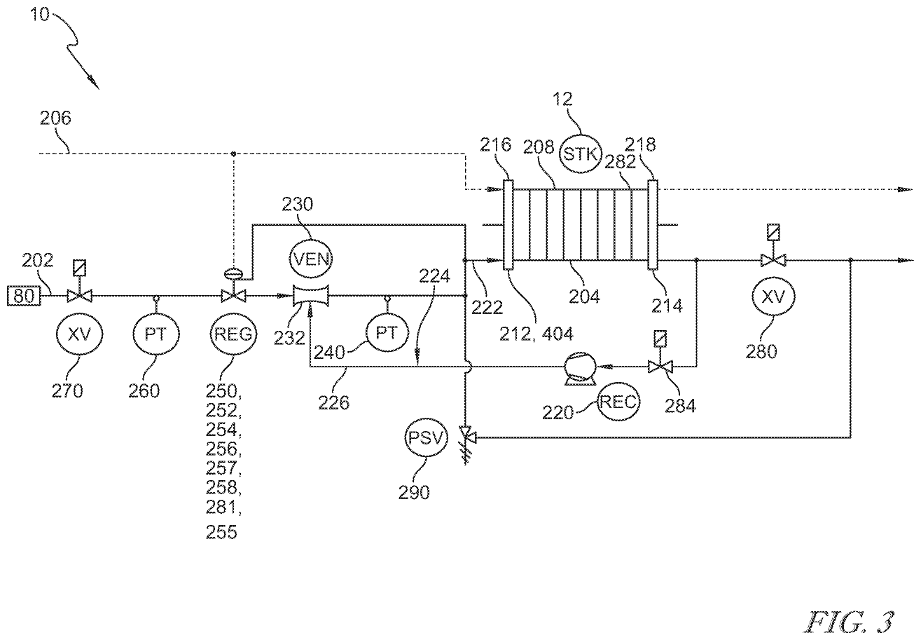

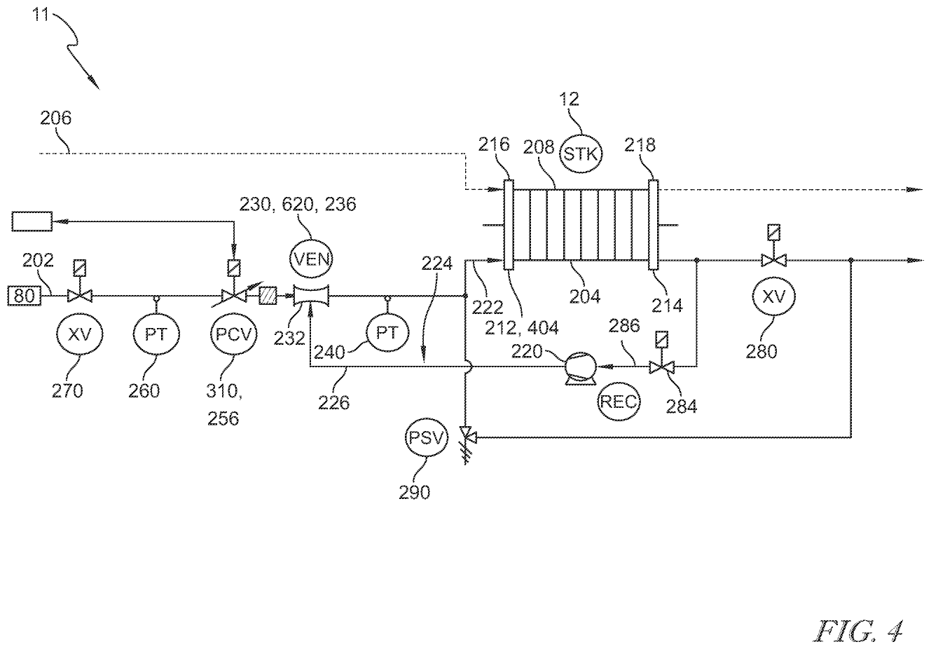

One embodiment of the operating characteristics of a fuel cell system 10 comprising a fuel cell 20 or fuel cell stack 12 is illustrated in graph 101 in FIG. 2. Operating pressures and the associated operating temperatures are shown as a function of current density 108. The fuel cell 20 or fuel cell stack 12 may be required to operate within a pressure range known as anode inlet manifold pressure (P_{AIM}) measured at the anode inlet manifold 404 as shown in FIGS. 3 and 4.

A highest anode inlet manifold pressure (P_{AIM_HI}) of a fuel cell 20 or fuel cell stack 12 is denoted by 110. A lowest anode inlet manifold pressure (P_{AIM_HI}) of a fuel cell 20 or fuel cell stack 12 is denoted by 120. The range 160 between the highest anode inlet manifold pressure (P_{AIM_HI}) 110 and the lowest anode inlet manifold pressure (P_{AIM_LO}) 120 indicates a target anode inlet manifold pressure range or operating pressure. A target temperature of the fuel cell system 10 may range from a low fuel supply operating temperature (T_{CV_LO}) 102 to a high fuel supply operating temperature (T_{CV_HI}) 104.

It is critical to operate the fuel cell 20 or fuel cell stack 12 at a pressure that ranges from about or approximately the highest anode inlet manifold pressure (P_{AIM_HI}) 110 to about or approximately the lowest anode inlet manifold pressure (P_{AIM_LO}) 120 when the fuel cell 20 or fuel cell stack 12 is operating above a critical current density (i__{LO_CR}) 130. In some embodiments, the critical current density (i__{LO_CR}) 130 may be at about 0.7 A/cm². In other embodiments, the critical current density (i__{LO_CR}) 130 may be at about 0.6 A/cm². In some further embodiments, the critical current density (i__{LO_CR}) 130 may be higher or lower than 0.7 A/cm², such as ranging from about 0.5 A/cm² to about 0.9 A/cm², including every current density 108 or range of current density 108 comprised therein.

The fuel cell 20 or fuel cell stack 12 may operate at a high current density 138, which may be higher than the critical current density (i__{LO_CR}) 130. The high current density 138 may range from about 1.3 A/cm² to about 2.0 A/cm², or about 1.3 A/cm² to about 1.6 A/cm², or about 1.0 A/cm² to about 1.6 A/cm², including every current density 108 or range of current density 108 comprised therein.

In some embodiments, operating the fuel cell 20 or fuel cell stack 12 at such high current density 138 (e.g., at about 1.6 A/cm²) will result in operating the fuel cell 20 or fuel cell stack 12 at pressures and temperatures different from optimal target operating pressures and operating temperatures. Operating the fuel cell 20 or fuel cell stack 12 at pressures and temperatures different from the optimal target operating pressures and operating temperatures may lower the efficiency of the fuel cell 20 or fuel cell stack 12. Such operation may also result in damage to the fuel cell 20 or fuel cell stack 12 because of MEA 22 degradation (e.g., due to starvation, flooding and/or relative humidity effects).

In some embodiments, there may be more flexibility in the fuel cell 20 or fuel cell stack 12 operating pressure and operating temperature when the fuel cell 20 or fuel cell stack 12 is operating below the critical current density (i__{LO_CR}) 130. The present operating system comprising the fuel cell or fuel cell stack can operate at a minimum current density (i_{MIN}) 132 and/or a maximum current density (i_{MAX}) 134.

In one embodiment, the fuel cell system 10 comprising the fuel cell 20 or fuel cell stack 12 may operate in a functional range that may be different than that indicated by the curve 160 in FIG. 2. The fuel cell system 10 may operate at higher pressures (e.g., the highest anode inlet manifold pressure (P_{AIM_HI}) 110) or at a current density 108 as low as the critical current density (i__{LO_CR}) 130. For example, the fuel cell system 10 may extend steady state operation at about 2.5 bara down to about the critical current density (i__{LO_CR}) 130. Pressure measurements in bara refer to the absolute pressure in bar.

FIG. 3 illustrates one embodiment of a fuel cell system 10 comprising a fuel cell stack 12, a mechanical regulator 250, a recirculation pump or blower 220 in series or in parallel to the fuel cell stack 12, an exhaust valve 280, a purge valve 284, a shut off valve 270, a pressure transfer valve 290, one or more pressure transducers 240/260, and a venturi or an ejector 230. In some embodiments, the fuel cell system 10 may comprise one or more fuel cell stacks 12 and/or one or more fuel cells 20. In other embodiments, there may also be one or multiple valves, sensors, compressors, regulators, blowers, injectors, ejectors, and/or other devices in series or in parallel with the fuel cell stack 12. In some embodiments, the purge valve 284 is omitted.

In one embodiment of the fuel cell system 10, an anode inlet stream 222, flows through an anode 204 end of the fuel cell stack 12. Typically, the anode inlet stream 222 may be a mixture of fresh fuel (e.g., H₂) and anode exhaust (e.g., H₂ fuel and/or water). Conversely, oxidant 206 (e.g., air, oxygen, or humidified air) may flow through the cathode 208 end of the fuel cell stack 12.

Excess fuel may be provided at the anode inlet 212 to avoid fuel starvation towards the anode outlet 214. Water content of the anode inlet stream 222 or the relative humidity of the anode inlet stream 222 may impact the performance and health of the fuel cell stack 12. For example, low inlet humidity may lead to a drier membrane electrode assembly (MEA) 22 resulting in reduced performance. Low inlet humidity may also induce stresses that can lead to permanent damage to the membrane electrode assembly (MEA) 22.

High humidity levels may lead to flooding within the fuel cell 20 or fuel cell stack 12, which can induce local starvation and/or other effects that may reduce fuel cell performance and/or damage the membrane electrode assembly (MEA) 22. In some embodiments, there may be an optimal inlet relative humidity range in which fuel cell performance is improved and membrane electrode assembly (MEA) 22 degradation rate is minimized. For example, the fuel cell 20 or fuel cell stack 12 may achieve optimal performance when the relative humidity level of the anode inlet stream 222 is in the range of about 30% to about 35%, including any percentage or range comprised therein.

The source of the excess fuel and water content in a fuel cell 20 may be from a secondary or recirculated flow 226. Composition of the secondary flow 226 in the fuel cell system 10 is dependent on its composition of anode outlet stream 225. In some embodiments, the anode outlet stream 225 may be saturated with water at a given anode gas outlet temperature and pressure. Thus, the variation in the composition of the secondary flow 226 may be taken into account when determining a required secondary flow 226 to meet the excess fuel or relative humidity targets of the anode inlet stream 222.

The required flow rate of the secondary flow 226 can be determined by either the need for excess fuel, or by the need for increased water content, whichever calls for a higher flow of the secondary flow 226. The required flow of the secondary flow 226 can be expressed as the target entrainment ratio (ER). The entrainment ratio (ER) is defined as the ratio of mass flow rate of the low pressure stream (e.g., the secondary mass flow rate) to the mass flow rate of the high pressure stream (e.g., the primary mass flow rate). Alternatively, a target effective excess fuel ratio or a minimum required fuel ratio may account for either the need for excess fuel, or for the increased water content of the anode inlet stream 222.

Excess fuel ratio (λ) or the anode stoichiometry ratio is defined as the ratio of anode inlet stream 222 flow rate to the fuel consumed in the fuel cell 20 or fuel cell stack 12. Excess fuel ratio (λ) may be used to represent the required composition of the secondary flow 226 to meet the required anode inlet stream 222 characteristics. The required anode inlet stream 222 characteristics may be the more stringent of excess fuel ratio or relative humidity requirements of the fuel cell system 10. Minimum required excess fuel ratio (λ) 140 as a function of current density 108 is shown in FIG. 2. In some embodiments, the fuel cell system 10 requires or may require a fuel amount at or above the minimum required excess fuel ratio (λ) 140.

In other embodiments, the fuel cell system 10 may require a target water or humidity level, which may affect the excess fuel ratio (λ) 140. The excess fuel ratio (λ) 140 may be flat across the fuel cell system 10 operating range except at low current densities 108, such as at a current density 108 at or below an excess fuel ratio current density threshold (i__{λ_THV}) 150. Alternatively, or additionally, the excess fuel ratio (λ) 140 may change with a change in current density 108.

In some embodiments, the excess fuel ratio (λ) 140 above the excess fuel ratio current density threshold (i__{λ_THV}) 150 may be in the range from about 1.3 to about 1.9, including any ratio comprised therein. In one preferable embodiment, the excess fuel ratio (λ) 140 above the excess fuel ratio current density threshold (i__{λ_THV}) 150 may be in the range of about 1.4 to about 1.6, including any ratio or range of ratio comprised therein.

In some embodiments, the excess fuel ratio current density threshold (i__{λ_THV}) 150 of the fuel cell system 10 may be at or about 0.2 A/cm². In other embodiments, the excess fuel ratio current density threshold (i__{λ_THV}) 150 may be at a different current density 108. For example, the excess fuel ratio current density threshold (i__{λ_THV}) 150 may be at a current density 108 in the range of about 0.05 A/cm² to about 0.4 A/cm², including any current density 108 or range of current density 108 comprised therein. In one preferable embodiment, the excess fuel ratio current density threshold (i__{λ_THV}) 150 may be about 0.1 A/cm² or about 0.2 A/cm². The excess fuel ratio current density threshold (i__{λ_THV}) 150 may depend on the operating conditions of the fuel cell 20 or fuel cell stack 12.

In one embodiment, if the fuel cell 20 or fuel cell stack 12 is operating below the excess fuel ratio current density threshold (i__{λ_THV}) 150, a minimum volumetric flow rate may be maintained through the anode 204 to flush out any liquid water that might form in the fuel cell 20 or fuel cell stack 12. At low flow rates (e.g., below about 0.2 A/cm² or below about 0.1 A/cm²), there may be flooding in the fuel cell 20 or fuel cell stack 12. If the minimum volumetric flow rate is below the excess fuel ratio current density threshold (i__{λ_THV}) 150, the rate of fuel cell 20 or fuel cell stack 12 degradation may increase and the performance of the fuel cell or fuel cell stack may be adversely affected.

The venturi or an ejector 230 may be used in the fuel cell system 10. The venturi or ejector 230 may be sized, such that the fuel cell system 10 may not require the assistance of a recirculation pump 220, such as a blower, at certain current densities 108. Absence of usage of the recirculation pump or blower 220 may result in a decrease in parasitic load, as shown by the curves 170 and 180 of FIG. 2. The curve 170 shows a fraction of flow that is delivered by the recirculation pump or blower 220 in the absence of a venturi or ejector 230. The curve 180 shows the corresponding parasitic load.

The parasitic load may increase with an increase in current density, as shown by the curve 180. This is because the recirculation pump or blower 220 may function at a capacity proportional to pressure loss in the fuel cell 20 or fuel cell stack 12 and/or proportional to the required flow rate of the secondary flow 226 in the fuel cell 20 or fuel cell stack 12. The fuel cell 20 or fuel cell stack 12 may be initially operating at high current density 138 and/or at high operating temperatures and pressures, such that the fuel cell load under this initial operating condition is high. The fuel cell load is defined as:

Load=stack power=current×fuel cell or fuel cell stack voltage=current density×fuel cell area×fuel cell or fuel cell stack voltage.

The fuel cell 20 or fuel cell stack 12 may be in a load shedding state when the load demand for power is rapidly reduced or shed requiring the fuel cell 20 or fuel cell stack 12 to reduce the current delivered.

During transient operations in the fuel cell 20 or fuel cell stack 12, the operating pressure in the fuel cell 20 or fuel cell stack 12 may change based on the changes in the fuel cell 20 or fuel cell stack 12 operating temperature. For example, during load shedding, the fuel cell system 10 may have an operating pressure that corresponds to a transient operating pressure (P__{AIM_TRS}) that may be greater than its steady state operating pressure (P__{AIM_SS}). In some embodiments, the transient operating pressure (P__{AIM_TRS}) may equal the highest anode inlet manifold pressure (P_{AIM_HI}) 110 even at low current densities 108. During load acceptance, the rate of increase in current density 108 is limited, and the steady state operating pressure (P__{AIM_SS}) may equal the anode inlet manifold pressure (P_{AIM}).

In one embodiment, the operating pressure of the fuel cell 20 or fuel cell stack 12 may optimize the balance between enabling efficient fuel cell 20 or fuel cell stack 12 operation and the parasitic load required to operate at the chosen operating pressure (e.g., the parasitic load of an air compressor, a blower, and/or a pump). In some embodiments, the operating temperature, operating pressure, and/or excess air ratio 140 may maintain a target relative humidity (RH) for the fuel cell 20 or fuel cell stack 12 operation. The operating temperature, operating pressure, and/or excess air ratio 140 may be determined by targeting a specific value for the relative humidity (RH) at the cathode 208.

The excess air ratio is defined similarly to excess fuel ratio 140, but refers to the cathode 208 side flow (i.e., excess O₂ in the air). The combination of excess air ratio, pressure and temperature are used together to control humidity on the cathode 208 side, which in turn impacts water content on the anode 204 (H₂) side. In one embodiment, temperature, pressure, and excess air ratio that vary with current density may be used to control humidity on the cathode 208 side. In some embodiments, excess air ratio may be about 2.0.

In other embodiments, excess air ratio may be in the range of about 1.7 to about 2.1, including any ratio or range of ratio comprised therein. In some other embodiments, excess air ratio may be in the range of about 1.8 to about 1.9, including any ratio or range of ratio comprised therein, under pressurized operation. Excess air ratio may increase to below an air threshold current to keep volumetric flow rate high enough to prevent flooding in the fuel cell 20 or fuel cell stack 12 on the cathode 208 side.

The target relative humidity (RH) may be maintained by using a humidification device in combination with the operating pressure and operating temperature. For example, a humidification device may be used on the cathode 208 side of the fuel cell 20 or fuel cell stack 12. If the target relative humidity (RH) and the target operating pressure of the fuel cell 20 or fuel cell stack 12 are specified, the target temperature for the fuel cell 20 or fuel cell stack 12 operation may be determined.

The mechanical regulator 250 is a control valve 254 that may be used to control the flow of fresh fuel 202 also referred to as primary flow, primary mass flow, primary fuel, or motive flow to the anode 204. Pressure differential between the gas streams (e.g. anode inlet stream 222 and air 206) at the anode 204 and the cathode 208 may provide an input signal 256 to a controller 252 in the mechanical regulator 250.

The controller 252 of the mechanical regulator 250 may determine the flow of the anode inlet stream 222 through an anode inlet 212 at the anode 204. The control valve 254 may be a proportional control valve, or an injector. In other embodiments, the control valve 254 may comprise an inner valve 258, coil 255, or solenoid 257 that controls the opening or closing of the control valve 254. The input signal 256 from the anode 204 and/or cathode 208 of the fuel cell 20 or fuel cell stack 12 may be a physical signal 256 or a virtual (e.g., an electronic) signal 256. The signal may be any type of communicative or computer signal 256 known in the art.

The mechanical regulator 250 is a control valve 254 that may be used to control the flow of fresh fuel 202 also referred to as primary flow, primary mass flow, primary fuel, or motive flow to the anode 204. Pressure differential between the gas streams (e.g. anode inlet stream 222 and air 206) at the anode 204 and the cathode 208 may provide an input signal 256 to a controller 252 in the mechanical regulator 250.

The controller 252 of the mechanical regulator 250 may determine the flow of the anode inlet stream 222 through an anode inlet 212 at the anode 204. The control valve 254 may be a proportional control valve, or an injector. In other embodiments, the control valve 254 may comprise an inner valve 258, coil 255, or solenoid 257 that controls the opening or closing of the control valve 254. The input signal 256 from the anode 204 and/or cathode 208 of the fuel cell 20 or fuel cell stack 12 may be a physical signal 256 or a virtual (e.g., an electronic) signal 256. The signal may be any type of communicative or computer signal 256 known in the art.

Flow rate of the primary flow 202, or a primary flow rate, may be controlled to match the fuel consumption in the fuel cell stack 12 based on the operating pressure (e.g., anode pressure). In some embodiments, the pressure in the anode 204 may stabilize when fuel consumption matches the fresh fuel feed at the anode 204 assuming that all other parameters are equal. Since the functioning of the mechanical regulator 250 is based on the pressure differential between the anode 204 and cathode 208, a target pressure differential needs to be maintained when using the mechanical regulator 250. In some embodiments, pressure at the cathode 208 is controlled and/or maintained at a target level via cathode side controls 282.

A mechanically regulated approach, such as by employing actuators 282, may use pressure signals 281 from a cathode/air inlet 216 to control mass flow and maintain an appropriate pressure on the cathode 208 side of the fuel cell stack 12. In some embodiments, pressure signals 218 from cathode 208 side are inputs to the mechanical regulator 250. In some embodiments, the anode 204 side mass flow and anode 204 side pressure may be controlled by using the pressure signals 281 from cathode 208 side and measuring one or more anode 204 side conditions.

The pressure signals 281 from cathode 208 side may change the position of an inner valve 258 in the mechanical regulator 250 to control mass flow through the mechanical regulator 250 and maintain the target pressure differential between the anode 204 and the cathode 208. The input signal 256 that acts on the mechanical regulator 250 is effectively a pressure differential that acts on a diaphragm 257 or other parts of the mechanical regulator 250. No other direct measurement of the pressure differential may be undertaken.

A single point pressure at the anode 204 may be calculated to be the cathode 208 side pressure plus the pressure differential between the gas streams (e.g., 222) at the anode 204 and the gas streams (e.g., 206) at the cathode 208. Single point pressure may be absolute pressure or gauge pressure.

The venturi or ejector 230 may draw the secondary flow 226, also referred to as secondary mass flow, entrainment flow, or recirculation flow, using a flow pressure across an anode gas recirculation (AGR) loop 224. As discussed later, the venturi or ejector 230 may take advantage of the available excess enthalpy from the higher pressure primary flow to draw in the secondary flow 226, working against the pressure losses through the AGR loop 224. The anode gas recirculation loop 224 may include the venturi or ejector 230, the fuel cell stack 12, and a secondary inlet 232, such as one comprised in a suction chamber 620 in the venturi or ejector 230, and/or other piping, valves, channels, manifolds associated with the venturi or ejector 230 and/or fuel cell stack 12. The recirculation pump or blower 220 may increase or decrease the differential pressure across the AGR loop 224.

The fuel cell system 10 may require a target water or humidity level, which may drive the flow of saturated secondary flow 226. The saturated secondary flow 226 may then drive the primary flow 202, such that the target excess fuel ratio (λ) 140 may be dependent on the target water or humidity level.

In one embodiment, the recirculation pump or blower 220 may be used to achieve the excess fuel ratio. The recirculation pump or blower 220 may operate across the entire operating range (current density) of the fuel cell stack 12. The parasitic load of the recirculation pump or blower 220 may be substantial. In one embodiment, a large recirculation pump or blower 220 may be required to provide the power to achieve the target excess fuel ratio (λ) 140. In some embodiments the use of the recirculation pump or blower 220 may be inefficient and expensive. The operating characteristics of a recirculation pump or blower 220 may be distinct from the operating conditions of the venturi or ejector 230.

A pressure lift capability of the recirculation pump or blower 220 (ΔP__{BLWR}) is a function of the flow through the recirculation pump or blower 220 (Q), the blower speed (N), and the density of the flow composition (ρ). The pressure lift of the recirculation pump or blower 220 (ΔP__{BLWR}) may be limited by power draw limits and/or speed limit of the fuel cell system 10. When the recirculation pump or blower 220 is not spinning or is operating under other fuel cell system 10 stall conditions, the recirculation pump or blower 220 may act as a restriction in the AGR loop 224.

ΔP__{BLWR}=f(Q,N,p)

As illustrated in the operating fuel cell system 11 shown in FIG. 4, a proportional control valve 310 may be used instead of a mechanical regulator 250. A proportional control valve 310 is electronically controlled and may provide more flexibility in controlling single point pressure at the anode 204 than the mechanical regulator 250. The proportional control valve 310 may be used to control the primary flow in the fuel cell system 11. In other embodiments, an injector (not shown) may be used instead of a proportional control valve 310.

The proportional control valve 310 may beneficially allow for active management of the differential pressure, may avoid droop issues, and/or provide flexibility in operating the fuel cell stack 12 under different operating conditions. Illustrative operating conditions may include, but are not limited to operating current density, operating pressure, operating temperature, operating relative humidity, fuel supply pressure, fuel supply temperature, required secondary flow, entrainment ratio, parasitic load limitations, power needs, pressure loses in the AGR loop 224, venturi or ejector 230 performance and/or efficiency, recirculation pump or blower 220 performance and/or efficiency, fuel density, purge flow 286 from the purge valve 284, and choked or unchoked (e.g., not choked) flow conditions.

The turn down ratio of the fuel cell system 10/11 is defined as the ratio of the maximum capacity of the venturi or ejector 230 to the minimum capacity of the venturi or ejector 230. The venturi or ejector 230 may draw the recirculation flow 226 using a primary flow exergy. The turn down ratio characterizes the range over which the venturi or ejector 230 can deliver the required excess fuel ratio (λ) 140 to the fuel cell stack 12. The fuel cell system 10/11 may be designed to maximize the venturi or ejector 230 turn down ratio. Consequently, maximizing the turn down ratio of the venturi or ejector 230 also works to minimize the size and parasitic load associated with the recirculation pump or blower 220. In some embodiments, the venturi or ejector 230 may be required to operate and/or perform robustly to deliver the required primary flow 202 at the required excess fuel ratio (λ) 140.

In one embodiment, a fuel supply system 80 may supply fuel at a fuel supply pressure (P_{CV}) and a fuel supply temperature (T_{CV}). The primary flow 202 may pass through the control valve 254 and enter the venturi or ejector 230 through a primary nozzle 236 at a primary nozzle inlet pressure (P_{O}) and a primary inlet temperature (T_{O}). The secondary flow 226 may enter the venturi or ejector 230 through a secondary inlet or entrance 232 in a suction chamber 620 at a secondary inlet pressure (P_{S}) and a secondary inlet temperature (T_{D}).

In some embodiments, the sizing pressure (P__{CV_MIN}) may be a minimum inlet pressure at a control valve 254 such as the proportional control valve 310 or mechanical regulator 250 or injector. In other embodiments, fuel sizing pressure (P__{CV_MIN}) may be the pressure at the inlet of a control valve 254 under empty pressure conditions (P_{EMPTY}). The secondary flow 226 may enter the venturi or ejector 230 through a secondary inlet 232 in a suction chamber 620 at a secondary inlet pressure (P_{S}) and a secondary inlet temperature (T_{S}).

The venturi or ejector 230 may have energy available in primary flow to induce the anode gas recirculated flow as the secondary flow 226 in the venturi or ejector 230. The stack pressure (ΔP_{STACK}) is the pressure loss through the AGR loop 224. The secondary flow 226 may be lifted against the stack pressure (ΔP_{STACK}).

The pressure lift (ΔP_{LIFT}) is the pressure required to overcome the pressure loses in the AGR loop 224 (ΔP_{STACK}) In some embodiments, the pressure lift (ΔP_{LIFT}) may be dominated by the pressure losses through the fuel cell stack 12 or any other component of the AGR loop 224. In some embodiments, pressure losses may be proportional to volumetric flow rate through one or more manifolds and/or channels in the AGR loop 224. In other embodiments, the volumetric flow 222 at anode inlet 212 may include a mixture of fresh fuel (e.g., H₂) as the primary flow 202 and the recirculation flow 226.

The secondary inlet pressure (P_{S}) may depend on the anode inlet manifold pressure (P_{AIM}) of the fuel cell or fuel cell stack 12 and the pressure loses in the AGR loop 224 (ΔP_{STACK}) or the required pressure lift (ΔP_{LIFT}).

P_{S}=P_{AIM}−ΔP_{LIFT}

The amount of secondary flow 226 that can be entrained is dictated by the boundary conditions of the fuel cell system 10/11 and the efficiency of the venturi or ejector 230. In some embodiments, the boundary conditions may be the primary nozzle inlet pressure (P_{O}), the secondary inlet pressure (P_{S}), the anode inlet manifold pressure (P_{AIM}) of the fuel cell or fuel cell stack 12, and/or secondary flow 226 composition. In some embodiments, the secondary flow 226 from the anode outlet 214 to the venturi or ejector secondary inlet 232 is an adiabatic process. The primary inlet temperature (T_{O}) and the secondary inlet temperature (T_{S}) of the venturi or ejector 230 may affect secondary flow 226.

As described earlier, above a certain critical current density (i__{LO_CR}) 130, the fuel cell system 10/11 is required to operate in the target anode inlet manifold pressure range indicated by the curve 160 in FIG. 2. The primary inlet pressure (P_{O}) may decrease proportionally with primary fuel demand, until the primary nozzle 236 is no longer choked (i.e., unchoked). In other embodiments, if the primary nozzle 236 is unchoked, the rate of decrease of the primary inlet pressure (P_{O}) may be non-linear and/or may be sensitive to downstream pressure such as the secondary inlet pressure (P_{S}). In other embodiments, the primary inlet pressure (P_{O}) may decrease as the primary inlet temperature (T_{O}) decreases.

The primary inlet temperature (T_{O}) may be equal to the fuel supply temperature (T_{CV}). The primary inlet temperature (T_{O}) may affect the primary flow 202. In some embodiments, the fuel cell system 10/11 may have a target mass flow rate. In other embodiments, the secondary inlet temperature (T_{S}) may influence the secondary flow 226 through geometric constraints of the secondary inlet 232 and/or the venturi or ejector 230. In some embodiments, the secondary inlet temperature (T_{S}) may be a geometric constraint. The thermodynamic constraints and/or venturi or ejector 230 efficiency may also influence the secondary flow 226.

The venturi or ejector 230 may be sensitive to the primary nozzle inlet pressure (P_{O}), the backpressure, and the required pressure lift (ΔP_{LIFT}). The backpressure may be an exit pressure at an ejector exit 238 (P_{C}) or may be the anode inlet manifold pressure (P_{AIM}). If there are no pressure losses to the anode inlet manifold from the venturi or ejector 230 outlet, the exit pressure at the ejector exit 238 (P_{C}) may be equal to the anode inlet manifold pressure (P_{AIM}). In some embodiment, the primary nozzle inlet pressure (P_{O}) may be a function of the current density (i) in the fuel cell system 10/11.

P_{O}=f(i)

Entrainment ratio (ER), which is a measure of the performance and/or capability of the venturi or ejector 230 and may be sensitive to the primary nozzle inlet pressure (P_{O}), the backpressure (e.g., P_{C}, P_{AIM}) and/or the pressure lift (ΔP_{LIFT}) In one embodiment, as backpressure (e.g., P_{C}, P_{AIM}) increases, the venturi or ejector 230 may change from being double choked (with a stable entrainment ratio), to being in a transitioning condition (with a decreasing entrainment ratio), to having a reverse flow. Reverse flow in the venturi or ejector 230 may be undesirable as reverse flow indicates no fuel recirculation through the AGR loop 224. In some embodiments, the venturi or ejector 230 may need to offset pressure losses through the fuel cell or fuel cell stack 12 (ΔP_{STACK}), while operating against the backpressure (e.g., P_{C}, P_{AIM}).

In one embodiment, the reversible entrainment ratio (RER) or the reversible portion of the entrainment ratio (ER) based on the thermodynamic limits, is defined as:

RER=−Δχ__{M}/Δχ__{S}

Δχ__{M} is the motive flow exergy and Δλ__{S} is the entrained flow exergy.

In one embodiment, if the minimum and maximum anode inlet manifold pressures (P_{AIM_LO} 120 and P_{AIM_HI} 110, respectively) are known, the low break point (i.e. current density) at which the pressure is the minimum anode inlet manifold pressure P_{AIM_LO} 120 (i__{LO_BRK}) and the high break point (i.e. current density) at which the pressure is the maximum anode inlet manifold pressure P_{AIM_HI} 110 (i__{HI_BRK}) may be determined.

In one embodiment, the effective efficiency of the venturi or ejector 230 (η_eff_ejc) is critical in determining if/or when the recirculation pump or blower 220 support is required to deliver the target entrainment ratio (ER__{target}). In some embodiments, the effective efficiency of the venturi or ejector 230 (η_eff_ejc) may be a measure of the overall efficiency of the venturi or ejector 230 and depend on the efficiency of the various components of the venturi or ejector 230 (η_ejc). In other embodiments, the effective efficiency of the venturi or ejector 230 (η_eff_ejc) may depend on the fuel cell system 10/11 operating conditions. In some other embodiments, the effective efficiency of the venturi or ejector 230 (η_eff_ejc) may depend on the venturi or ejector 230 design, the position of nozzle relative to mixer inlet, and/or efficiency of different components of the venturi or ejector 230.

The fuel cell system 10/11 may have a purge flow 286 to remove water, nitrogen (N₂), and/or other contaminants from the fuel cell system 10/11. The purge flow 286 may remove other gases from the fuel cell system 10/11. The primary nozzle of the venturi or ejector 230 may allow primary mass flow (plus any purge flow 286) at a maximum current density for a given fuel supply system pressure (P_{CV}), fuel supply temperature (T_{CV}), and/or the characteristics of the control valve.

The venturi or ejector 230 may be sized such that the venturi or ejector 230 may be able to support the entrainment ratio (ER) at high current densities. In some embodiments, such sizing of the venturi or ejector 230 may increase the parasitic savings by decreasing the size of the recirculation pump or blower 220 used in the fuel cell system 15.

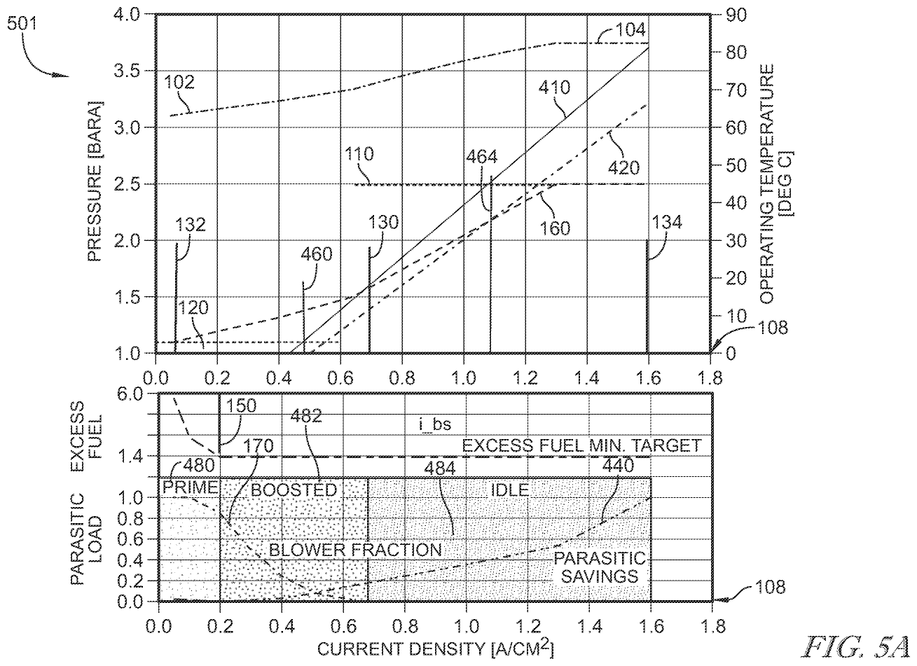

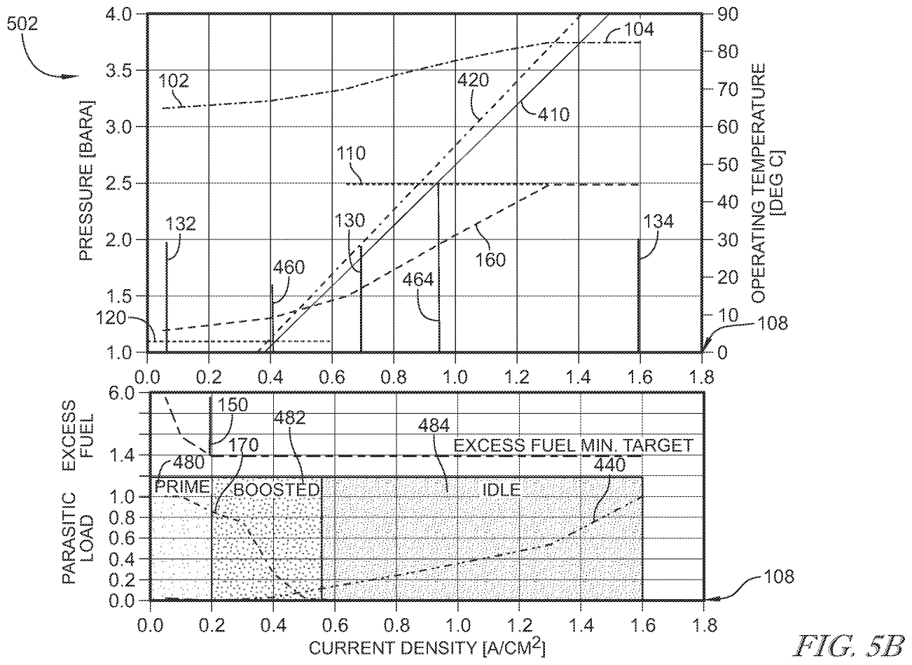

Graph 501 in FIG. 5A illustrates the operating range for a venturi or ejector 230 under choked conditions, and graph 502 in FIG. 5B illustrates the operating range for the venturi or ejector 230 under choked and unchoked conditions. In one embodiment, as shown in FIGS. 5A and 5B, the curve 160 indicates the target anode inlet manifold pressure range as determined by fuel cell stack 12 design. Above a critical current density (i__{LO_CR}) 130, it may be essential to operate the fuel cell system 10/11 at the target anode inlet manifold pressure range which lies in the range indicated by 160.

In the illustrated embodiment, the critical current density (i__{LO_CR}) 130 is about 0.7 Amps/cm². The maximum anode inlet manifold pressure (P_{AIM}) preferred by the venturi or ejector 230 i.e. maximum ejector pressure (P__{AIM_EJCT_MAX}) preferred by the venturi or ejector 230 as a function of current density is shown by the curve 410. The maximum ejector pressure (P__{AIM_EJCT_MAX}) preferred by the venturi or ejector 230 is sensitive to the primary inlet temperature (T_{O}) as shown by the curve 420.

The maximum ejector pressure (P__{AIM_EJCT_MAX}) may vary according to the limits and ranges fuel supply system. In one embodiment, the current density at which the maximum ejector pressure (P__{AIM_EJCT_MAX}) curve 410 intersects the maximum anode inlet manifold pressures (P_{AIM_HI}) 110 is defined as the high current density ejector threshold (i__{HI_THV}) 464. In one embodiment, the current density at which the maximum ejector pressure (P__{AIM_EJCT_MAX}) curve 410 intersects the minimum anode inlet manifold pressures (P_{AIM_HI}) 120 is defined as the low current density ejector threshold (i__{LO_THV}) 460.

In one embodiment, if the maximum ejector pressure (P__{AIM_EJCT_MAX}) is greater than the anode inlet manifold pressure (P_{AIM}), the venturi or ejector 230 may operate under primary nozzle 236 choked conditions, which is a robust ejector state. In some embodiments, though the venturi or ejector 230 can still entrain flow if the anode inlet manifold pressure (P_{AIM}) is greater than the maximum ejector pressure (P__{AIM_EJCT_MAX}), the venturi or ejector 230 may become more sensitive to the boundary conditions. In other embodiments, the ability of the venturi or ejector 230 to continue to meet the entrainment ratio (ER) requirements may become more sensitive to the pressure lift (ΔP__{LIFT}) if the anode inlet manifold pressure (P_{AIM}) is greater than the maximum ejector pressure (P__{AIM_EJCT_MAX}).

In one embodiment, the venturi or ejector 230 configuration may be sized to fully deliver the recirculation flow 226 at the critical current density (i__{LO_CR}) 130 taking into account the differential pressure across the AGR loop 224. In some embodiments, the venturi or ejector 230 configuration may be sized to fully deliver the recirculation flow 226 without the assistance of the recirculation pump or blower 220. Absence of usage of the recirculation pump or blower 220 may result in a decrease in parasitic load as shown by the curves 170 and 440. The curve 170 shows the fraction of the recirculated flow that is delivered by the recirculation pump or blower 220 and the curve 440 shows the corresponding parasitic savings. The curve 440 illustrating the parasitic savings 440 is inversely related to the curve 170 illustrating the fraction of the recirculated flow that is delivered by the recirculation pump or blower 220.

In one embodiment, the empty pressure (P EMPTY) limit is especially important and may be set high enough such that the venturi or ejector 230 can deliver the recirculation flow 226 without the assistance of recirculation pump or blower 220 to meet the recirculation flow requirement under nominal conditions

The maximum ejector pressure preferred by the venturi or ejector 230 (P__{AIM_EJCT_MAX}) may depend on primary fuel inlet temperature (T_{O}). The curve 420 illustrates the maximum ejector pressure (P__{AIM_EJCT_MAX}) when the primary fuel inlet temperature (T_{O}) is the same as the primary nozzle inlet sizing temperature (T_{O_SZ}). Thus, the venturi or ejector 230 can be shifted into a regime under which its performance is less robust because of the primary fuel inlet temperature (T_{O}).

In one preferable embodiment, the venturi or ejector 230 is designed such that the venturi or ejector 230 can continue to robustly meet any entrainment ratio (ER) requirements at low current densities. In some embodiments, the venturi or ejector 230 can continue to meet entrainment ratio (ER) requirements at a current density as low as the excess fuel ratio current density threshold (i__{λ_THV}) 150 in FIG. 5A and FIG. 5B. The benefits of a configuration where the venturi or ejector 230 can continue to meet entrainment ratio (ER) requirements at such low current densities is illustrated by the curve showing parasitic savings 440. In one embodiment, the venturi or ejector 230 and recirculation pump or blower 220 may be operated simultaneously. In other embodiments, the recirculation pump or blower 220 may be sized smaller to increase the parasitic savings and/or reduce fuel cell system 10/11 cost, size, or weight.

In one embodiment, the fuel supply system 80 and the operating conditions of the fuel cell stack 12 (e.g., pressure, temperature, recirculation flow requirements, and stack differential pressure etc.) may affect the operation and/or performance of the venturi or ejector 230. In other embodiments, the composition of the fuel cell stack 12 exhaust gas (e.g., water content, N₂ content etc.) may affect the operation and/or performance of the venturi or ejector 230.

In one embodiment, the geometric configuration and/or design of the venturi or ejector 230 may affect the operation and/or performance of the venturi or ejector 230. In some embodiments, the geometric configuration and/or design of the venturi or ejector 230 may be altered to enhance the operation and/or performance of the venturi or ejector 230 at low current densities. In other embodiments, the venturi or ejector 230 may be configured and/or designed in view of the factors affecting the operation and/or performance of the venturi or ejector 230. The factors affecting the operation and/or performance of the venturi or ejector 230 may include but are not limited to the fuel system supply, the operating conditions of the fuel cell stack 12, and/or the composition of the fuel cell stack 12 exhaust gas.

In one embodiment, as shown in FIGS. 3 and 4, if the recirculation pump or blower 220 is upstream of the venturi or ejector 230, the flow rate (Q) through the recirculation pump or blower 220 corresponds to the recirculation flow through the anode recirculation loop 224. For example, if the entrainment ratio (ER) is equal to 2.0, then flow through the recirculation pump or blower 220 (Q) is ⅔ of the total fuel 222 flow (primary fuel flow 202+recirculation fuel flow 226).

In one embodiment, the venturi or ejector 230 and the recirculation pump or blower 220 may be optimally integrated and/or sized to enhance the operation and/or performance of the venturi or ejector 230 in the fuel cell stack 12. In some embodiment, the recirculation pump or blower 220 may be sized to deliver pressure lift (ΔP_{LIFT}) to offset any pressure losses through the anode recirculation loop 224. In other embodiments, the recirculation pump or blower 220 may be sized to support the operation and/or performance of the venturi or ejector 230 in the fuel cell stack 12 under varying operating conditions. The operating conditions may include, but may not be limited to pseudo-steady state condition and transient conditions.

In one embodiment, the recirculation pump or blower 220 may exist in different states of operation. In one embodiment, the recirculation pump or blower 220 may be in an idle state 484 and the venturi or ejector 230 may operate without recirculation pump or blower 220 support.

In one embodiment, the recirculation pump or blower 220 may be in a blower prime state 480, i.e. the current density may be below excess fuel ratio current density threshold (i__{λ_THV}). Under such conditions, the performance and/or operation of the venturi or ejector 230 may be challenged and the venturi or ejector 230 may operate with recirculation pump or blower 220 support. In one embodiment, the recirculation pump or blower 220 may primarily deliver the required recirculation flow through the recirculation anode loop 224. In other embodiments, the blower pressure (ΔP_{BLWR}) may adjust to provide sufficient recirculation flow fuel flow to match the fuel cell stack 12 excess fuel requirement in the system 10/11.

In one embodiment, the recirculation pump or blower 220 may be in a ejector support state 582 where the venturi or ejector 230 may be boosted by the recirculation pump or blower 220. The current density may be greater than excess fuel ratio current density threshold (i__{λ_THV}) but less than a low break point current density at which the minimum anode inlet manifold pressure (P_{AIM_LO}) 120 may be set (i__{LO_BRK}). The recirculation pump or blower 220 blower may be providing a part of the recirculating flow.

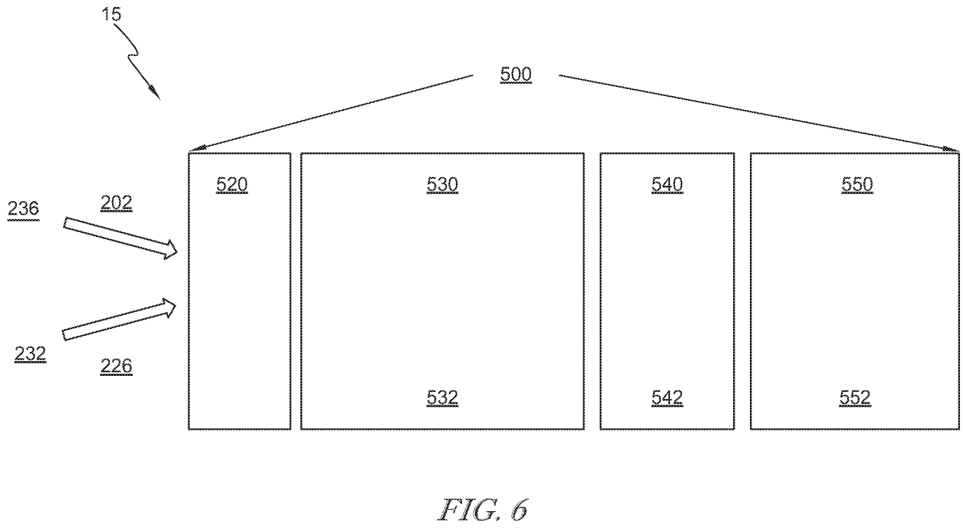

As shown in a fuel cell system 15 in FIG. 6, the anode gas recirculation composition 226 comprising the entrained flow enters the entrance 520 of the venturi or ejector 230 at the secondary inlet pressure (P_{S}) and secondary inlet temperature (T_{S}). A certain amount of the fresh fuel 202 exiting the fuel supply comprising the motive flow 202 enters the entrance 520 of the venturi or ejector 230 at the primary nozzle inlet pressure (P_{O}) and primary inlet temperature (T_{O}). The fresh fuel 202 and the anode gas recirculation composition 226 are mixed in the region 530 of the venturi or ejector 230 under mixing conditions that may include mixing under constant pressure to form a fuel stream 532.

The fuel stream 532 may go through a shock wave to form a fuel stream 542 in the shock section 540 of the venturi or ejector 230 before passing to the diffuser 550. A shock wave may form in the shock section 540 if the Mach number of the flow 542 is greater than 1.0. The fuel stream 552 exiting the diffuser 550 has a diffuser temperature (T_{C}) and diffuser pressure (P_{C}) in the diffuser 550 of the venturi or ejector 230. Fuel stream 552 leaves the diffuser 550 of the venturi or ejector 230 and enters the fuel stack 12.

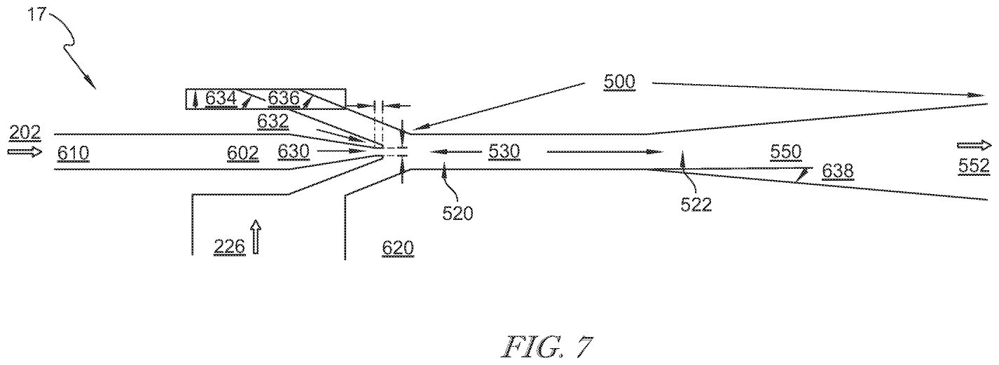

As shown in a fuel cell system 17 in FIG. 7, the entrance of the venturi or ejector 230 comprises primary nozzle inlet 610, the primary nozzle outlet 630, and the secondary flow inlet suction chamber 620. The motive flow 202 enters the venturi or ejector 230 at the primary nozzle inlet 610 and passes though the primary nozzle outlet 630, before entering the mixer entrance 520. The narrowest part of the primary nozzle 236 may be a throat of the primary nozzle 602. The throat or the narrowest part of the primary nozzle 602 may be the same as or different from the primary nozzle outlet 630.

Geometric configuration and/or design of the venturi or ejector 230 may comprise parameters such as the ejector nozzle or primary nozzle inlet area (A__{nzl}), mixer area ratio (MAR), or mixer length ratio (MLR). The primary nozzle inlet area (A__{nzl}) may limit the flow rate of the primary flow 202 for a given set of operating or boundary conditions of the fuel cell system 10/11.

The mixer area is the area available for the primary flow 202 and secondary flow 226 to flow through while mixing in the mixer region 530. The mixer area ratio (MAR) is the ratio of the cross-sectional area of the mixer region 530 to the cross-sectional area of the throat of the primary nozzle 602. The cross-sectional area of the mixer region 530 may be normal to the flow direction. The mixer length ratio (MLR) determines the volume available for primary 202 and secondary (entrained) 226 flows to mix in the mixer region 530 and develop a flow field before entering the diffuser 550. The mixer length ratio (MLR) is the ratio of the length of the mixer region 530 length to the diameter of the mixer region 530.

In one illustrated embodiment, as shown in FIG. 7, the area of the mixer region 530 is constant for the entire length of the mixer region 530. In other embodiments, the area of the mixer region 530 is not constant for the entire length of the mixer region 530. The mixer region 530 may have an inlet mixer area at the mixer entrance 520 and an outlet mixer area at the mixer outlet 522. The mixer area ratio (MAR) may be the ratio of the inlet area of the mixer region 530 to the area of the area of the throat of the primary nozzle 602. The mixer area ratio (MAR) may be the ratio of the inlet area of the mixer region 530 to the area of the primary nozzle outlet 630.

The geometric configuration and/or design of the suction chamber 620 of the venturi or ejector 230 may comprise parameters such the nozzle to mixer inlet distance (N2M) 632, and the converging angle at mixer inlet (α_{ES}) 634, 636. The nozzle to mixer inlet distance (N2M) 632 and/or the converging angle at mixer inlet (α_{ES}) 634, 636 in the suction chamber 620 is designed to minimize losses as the secondary flow is accelerated by the suction created by the primary flow 202 as it exits the primary nozzle 236 and/or to maximize the suction as the primary 202 and secondary 226 flows enter the mixer entrance 520.

The nozzle to mixer inlet distance ratio (N2M) may be about 1 to about 4, or about 4 to about 6, or about 6 to about 10, including any ratio or range of ratio included in the range therein. In some embodiments, the nozzle to mixer inlet distance ratio (N2M) may be 0, i.e., the nozzle outlet may be at the same plane as the mixer inlet. The exit point from the primary nozzle 236 may be inside the mixer 500. In other embodiments, the nozzle to mixer inlet distance ratio (N2M) may be negative, i.e., −2 to 0, including any ratio or range or ratio included in the range therein.

The ratio of the nozzle to mixer inlet distance (N2M) to the diameter of the primary nozzle 236 may be about 1 to about 10, including any ratio included in the range therein. In some embodiments, if the ratio of the nozzle to mixer inlet distance (N2M) to the diameter of the primary nozzle 236 is optimally sized for the lowest current density operating point, the ratio of the nozzle to mixer inlet distance (N2M) to the diameter of the primary nozzle 236 may be about 0 to about 5, including any ratio included in the range therein. The ratio of the nozzle to mixer inlet distance (N2M) to the diameter of the primary nozzle 236 may be higher if it was optimized for the highest current density operating point.

In one embodiment, the geometric configuration and/or design of the diffuser 550 of the venturi or ejector 230 may comprise parameters such the diffuser diverging angle (α_{DIFF}) In some embodiments, the diffuser diverging angle (α_{DIFF}) 538 is designed to be shallow enough to avoid flow separation of the flow stream 552 during deceleration in the diffuser 550.

The geometric parameters such as the ratio of area of the primary nozzle inlet 610 to the area of the primary nozzle outlet 630 (PAM), the ratio of the area of the secondary inlet 232 to the area of the inlet of the mixer region 530 (SAM), and/or the ratio of area of the outlet of the diffuser 550 to the area of the outlet of the mixer region 530 (DAM) may also affect the performance and/or operation of the venturi or ejector 230. The ratio of primary nozzle inlet area to the mixer inlet area (PAM) may be greater than the mixer area ratio (MAR).

The ratio of the area of the secondary inlet 232 to the area of the inlet of the mixer region 530 (SAM) may be designed to meet the highest current density operating point. In some embodiments, the ratio of the area of the secondary inlet 232 to the area of the inlet of the mixer region 530 (SAM) may be greater than 5 so that the inlet velocity of the secondary flow 226 at the mixer entrance 520 may be less than about 100 m/s. The ratio of the area of the secondary inlet 232 to the area of the inlet of the mixer region 530 (SAM) may be greater than 10 so that the inlet velocity of the secondary flow 226 at the mixer entrance 520 may be less than about 50 m/s.

The ratio of area of the outlet of the diffuser 550 to the area of the outlet of the mixer region 530 (DAM) may be chosen to balance the venturi or ejector 230 exit velocity (Vc) of the fuel stream 552 with the size of the venturi or ejector 230. The ratio of area of the outlet of the diffuser 550 to the area of the outlet of the mixer region 530 (DAM) may be chosen in combination with the diffuser diverging angle (α_{DIFF}).

In one embodiment, the ratio of area of the outlet of the diffuser 550 to the area of the outlet of the mixer region 530 (DAM) may be designed to reduce the exit Mach number of the fuel stream 552 to about 0.05 to about 0.2, including any number or range comprised therein, when exiting the diffuser 550. To comply with the Mach number requirement, in some embodiments, the ratio of area of the outlet of the diffuser 550 to the area of the outlet of the mixer region 530 (DAM) required at the lowest current density operating point may be about 1.6 times the ratio of area of the outlet of the diffuser 550 to the area of the outlet of the mixer region 530 (DAM) required at the highest current density operating point.

In some embodiments, the ratio of area of the outlet of the diffuser 550 to the area of the outlet of the mixer region 530 (DAM) at the lowest current density operating point may be about 1.9 to about 7.3, including any ratio or range of ratio comprised therein. The ratio of area of the outlet of the diffuser 550 to the area of the outlet of the mixer region 530 (DAM) accounting for the highest current density operating point may be about 3 to about 7, including any ratio or range of ratio comprised therein. In some embodiments, when considering the highest current density operating point, the ratio of area of the outlet of the diffuser 550 to the area of the outlet of the mixer region 530 (DAM) may be as high as from about 7 to about 12, including any ratio or range comprised therein.

A method for determining the geometry of the venturi or ejector 230 may include a design process that takes into account the operating or boundary conditions that the venturi or ejector 230 must operate within. The operating or boundary conditions may include but are not limited to secondary inlet pressure (P_{S}) and ejector exit pressure (P_{C}), temperatures, water content in the entrained 226 flow, all of which may vary with operating current density. The venturi or ejector 230 may be sensitive to different ranges. For example, the venturi or ejector 230 capability across a range of pressure lift (ΔP_{LIFT}) requirements at the same primary flow rate may be assessed.

The method for determining the geometry of the venturi or ejector 230 may include determining a primary nozzle inlet area (A__{nzl}) to ensure that the required primary flow can be achieved at the highest operating point of the operating range. The mixer area ratio (MAR) may be recognized as an important design parameter. For example, the mixer area may restrict the overall mass flow rate under ‘double choked’ conditions i.e., when both the primary 202 and the secondary flow 226 are choked. The overall mass flow rate may be a combination of primary 202 and secondary flow 226. The primary flow 202 may enter the mixer entrance 520 as a jet that is interacting with the secondary flow 226 at the edges of the primary 202 flow jet. The primary 202 flow jet may effectively occupy a portion of the mixer region 530 area and the remaining mixer region 530 area may be available for the secondary flow 226. If the secondary 226 flow is choked, the mass flow rate may be influenced by the available area. The mixer region 530 may have an area large enough to allow the required primary flow 202 and secondary flow 226 rate under double choked condition.

In some embodiments, other parameters such as material surface roughness, presence of rounded edges, volumes and cross-section flow areas of various components and/or manufacturing tolerances of different materials or components of the venturi or ejector 230 may be optimized to maximize the entrainment ratio (ER) at any given operating (boundary) condition. The parameters may be determined through analysis, and then validated with one or more tests. In some embodiment, an ejector efficiency trade-off with mixer length may be considered when determining the geometry of the venturi or ejector 230. For example, initially, increasing the mixer length may improve pressure recovery in the diffuser 550. However, increasing the mixer length beyond what is needed for smooth entry of the flow stream, 542 into the diffuser 550 may increase frictional losses in the fuel cell system 10/11.

In one embodiment, suction chamber 620 parameters may be evaluated. For example, there may be a trade-off between the nozzle to mixer inlet distance (N2M) 632 and/or the converging angle at mixer inlet (a E s) 634, 636 such that there is an optimal distance and converging angle that reduces pressure losses in the suction chamber 620. The trade-offs between different geometry parameters may be explored at a single highest current density operating point. In some embodiments, the venturi or ejector 230 operation and/or performance at other operating conditions may be validated through analysis and testing.

A method to optimize the venturi or ejector 230 geometric configuration may comprise sizing the primary nozzle 236 based on the fuel supply pressure (P_{CV}), fuel supply temperature (T_{CV}) and the highest required mass flow rate of the fuel cell system 10/11 under a given set of operating (boundary) conditions. The sizing the primary nozzle 236 based on the fuel supply pressure (P_{CV}), fuel supply temperature (T_{CV}) and the highest required mass flow rate of the fuel cell system 10/11 under a given set of operating (boundary) conditions may include the purge flow rate of the fuel cell system 10/11.

The method to optimize the venturi or ejector 230 geometric configuration may estimate the thermodynamic entitlement of entrainment ratio (ER) based on the operating (boundary) conditions of the fuel cell system 10/11. The stack pressure (ΔP_{STACK}) in the fuel cell system 10/11 as a function of the operating current density may be experimentally or computationally determined and/or estimated. The venturi or ejector 230 pressure lift (ΔP_{LIFT}) requirements as a function of the operating current density may be experimentally or computationally determined and/or estimated.

The thermodynamic entitlement of entrainment ratio (ER) may be estimated by using the minimum target excess fuel ratio (λ__{TRGT}), the operating pressure, the anticipated composition of the secondary flow 226. In some embodiments, the anticipated composition of the secondary flow 226 may include water and/or inert gas contamination fraction. The thermodynamic entitlement of entrainment ratio (ER) may be estimated by determining and/or estimating transient (load shedding) requirement of the fuel cell system 10/11. The primary nozzle inlet pressure (P_{O}) may be estimated based on primary flow 202 and compressible gas relationships.

The method to optimize the venturi or ejector 230 geometric configuration may determine two operating points for the fuel cell system 10/11, a highest current density operating point, and a lowest current density operating point. The highest current density operating point represents the maximum current operation and the lowest current density operating point represents the minimum current operation. The highest current density operating point may or may not account for purge flow 286 in the fuel cell system 10/11.

The mixer area ratio (MAR) may be sized for the highest current density operating point of the fuel cell system 10/11. In some embodiments, at the lowest current density operating point, the mixer area ratio (MAR) sized for the highest current density operating point may allow about 2 to about 20 times more secondary flow 226 required to meet the entrainment ratio (ER). In some embodiments, the overall entrainment ratio (ER) entitlement may be about 2 to about 20 times the required entrainment ratio (ER). In other embodiments, the overall entrainment ratio (ER) entitlement may be effectively equal to the turn down ratio of the venturi or ejector 230. In one preferable embodiment, the overall entrainment ratio (ER) entitlement may be about 2.5, about 4, or about 8 times the required entrainment ratio (ER).

For example, if the mixer area ratio (MAR) is sized to allow about 16 times the required entrainment ratio (ER) at maximum current density, and if the maximum current density is about 1.6 Amps/cm², the lowest operating current density the fuel cell system 10/11 could operate at is about 0.1 Amps/cm². If the mixer area ratio (MAR) is sized to allow about 8 times the required entrainment ratio (ER) at maximum current density, and if the maximum current density is about 1.6 Amps/cm², the lowest operating current density the fuel cell system 10/11 could operate at is about 0.2 Amps/cm². If the mixer area ratio (MAR) is sized to allow about 4 times the required entrainment ratio (ER) at maximum current density, and if the maximum current density is about 1.6 Amps/cm², the lowest operating current density the fuel cell system 10/11 could operate at is about 0.4 Amps/cm². If the mixer area ratio (MAR) is sized to allow about 2.7 times the required entrainment ratio (ER) at maximum current density, and if the maximum current density is about 1.6 Amps/cm², the lowest operating current density the fuel cell system 10/11 could operate at is about 0.6 Amps/cm².

The geometric configuration of the venturi or ejector 230 may be selected to trade-off requirements under the lowest current density operating point and the highest current density operating point. In some embodiments, other geometries of the venturi or ejector 230 may be optimized for the lowest current density operating point

The operating range of the venturi or ejector 230 may be extended by sizing the primary nozzle 236 at the highest current density operating point based on the fuel sizing pressure (P__{CV_MIN}) and fuel sizing temperature (T__{CV_SZ}) values. The fuel cell system 10/11 may have an instantaneous purge rate or purge fraction which may be different from the average purge rate or purge fraction of the fuel cell system 10/11 at different operating current densities. The primary nozzle 236 may be sized using the average purge rate at the highest current density operating point. Additionally, or alternatively, the primary nozzle 602 may be sized using the instantaneous purge rate at the highest current density operating point. Additionally, or alternatively, the primary nozzle 236 may be sized using the maximum instantaneous purge rate of the fuel cell system 10/11.

The operating range of the venturi or ejector 230 may be extended by choosing a minimum mixer area ratio (MAR) that allows the target excess fuel ratio (λ__{TRGT}) to be achieved at the highest current density operating point. The mixer area ratio (MAR) may be minimized such that the required entrainment ratio (ER) of the fuel cell system 10/11 at the highest current density operating point may be equal to the target entrainment ratio (ER) at that current density given a set of system operating (boundary) conditions. The mixer area ratio (MAR) may be chosen such that the venturi or ejector 230 may operate under double choked conditions at the highest current density operating point.

If the primary nozzle of the venturi or ejector 230 is sized according to the fuel supply pressure (P_{CV}) and the fuel supply temperature (T_{CV}) such that primary inlet pressure (P_{O}) is about 5.7 bara at maximum current flow rate with a primary inlet manifold pressure (PAM of about 2.5 bara, and target entrainment ratio (ER) of about 1.6, the mixer area ratio (MAR) may be chosen based on system pressure lift (ΔP_{LIFT}) and based on the effective efficiency (η_eff_ejc) of the venturi or ejector 230. Additionally, or alternatively, if the system comprises a no loss venturi or ejector 230 i.e. a venturi or ejector 230 with a 100% effective (η_eff_ejc), a mixer area ratio (MAR) of 3.4 to 3.7 may be chosen for a pressure lift (ΔP_{LIFT}) range of about 5 kPa to 25 kPa. A larger mixer area ratio (MAR) may be required for higher pressure losses and lower ejector efficiency.

If a system comprises the venturi or ejector 230 with less than 100% effective efficiency (η_eff_ejc), the mixer area ratio (MAR) may need to be increased. If there were significant inefficiencies in different components of the venturi or ejector 230 such as the suction chamber 620, the mixer area ratio (MAR) may need to be increased to accommodate for the inefficiency. If there were losses in the mixer, the mixer area ratio (MAR) may need to be increased to accommodate for the inefficiency.

For example, if the primary inlet pressure (P_{O}) is about 5.7 bara at the maximum current flow rate with a primary inlet manifold pressure (P_{AIM}) of about 2.5 bara, the target entrainment ratio (ER) is about 1.6, and the venturi or ejector 230 comprises a suction chamber 620 with an efficiency of about 65% to about 50%, the mixer area ratio (MAR) may be about 4 to about 5.2 for a pressure lift (ΔP_{LIFT}) range of about 5 kPa to 25 kPa. In other embodiments, if the target entrainment ratio (ER) is reduced about 1.4 because of lower excess fuel ratios (e.g., for an excess fuel ratio of about 1.3) or because of lower water concentrations, to 1.4, the mixer area ratio (MAR) may be decreased to about 3.5 to about 4.1 if the other variable stay the same.

The mixer length ratio (MLR) and/or the diffuser diverging angle (α_{DIFF}) of the venturi or ejector 230 may be chosen to improve the efficiency of the venturi or ejector 230 operation. The operating range of the venturi or ejector 230 may be extended by choosing the mixer length ratio (MLR) and/or the diffuser diverging angle (α_{DIFF}) affecting diffuser expansion such that the mixer area ratio (MAR) is minimized at the highest current density operating point. Choosing the mixer length ratio (MLR) and/or diffuser expansion such that the mixer area ratio (MAR) is minimized at the highest current density operating point may entail that the mixer length ratio (MLR) is optimal at the highest current density operating point, and/or that the diffuser diverging angle (α_{DIFF}) is shallow enough to efficiently recover pressure. However, in some embodiments, the mixer length ratio (MLR) may be chosen on at the lowest current density operating point, as long as the mixer length ratio (MLR) chosen also suffices at the highest current density operating point.

The mixer length ratio (MLR) may be determined based on the highest current density operating point range and/or the lowest current density operating point range. The mixer length ratio (MLR) may be about 5 to about 10, including any ratio or range comprised therein. In some embodiments, the mixer length ratio (MLR) may be determined based on the lowest current density operating point range. At a lower operating, the flow is fully developed at shorter mixer length ratio (MLR). In some embodiments, it is preferable to have the mixer length ratio (MLR) be as short as possible to initiate pressure recovery in the diffuser 550. The mixer length ratio (MLR) may be about 3 to about 7, including any ratio or range comprised therein. The mixer length ratio (MLR) may be centered on a lower value to enable pressure recovery in the diffuser 550 at the lowest current density operating point.

In one embodiment, the diffuser diverging angle (α_{DIFF}) may range from about 6° to about 18°. The nominal diffuser diverging angle (α_{DIFF}) may be chosen to make the geometry of the venturi or ejector 230 steep to shorten the diffuser length (e.g., about 9°).

In one embodiment, the operating range of the venturi or ejector 230 may be extended by designing the suction chamber 620 to balance the requirements at the highest current density operating point and at the lowest current density operating point. The nozzle to mixer inlet distance (N2M) 632, and the converging angle at mixer inlet (α_{ES}) 634, 636 may be chosen to minimize losses through the suction chamber 620 at the highest operating current density point. The design of the suction chamber 620 may ensure that the velocity of secondary flow 226 at the exit plane of the primary nozzle has a Mach number below about 0.2. The nozzle to mixer inlet distance (N2M) 632, and the converging angle at mixer inlet (α_{ES}) 634, 636 may be optimized at the lowest operating current density point.

The operating range of the venturi or ejector 230 may be extended by accounting for noise factors such as primary fuel temperature, transient operation conditions, system purge flow requirements, any build-up of contaminants in the anode gas recirculation loop of the system. When sizing the minimum mixer area ratio (MAR) for the highest current density operating point, the minimum target excess fuel ratio (λ__{TRGT}) used for sizing may account for diluents such as gases, compounds etc. (e.g., N₂) that may build up in the anode recirculation loop 224. In some embodiments, accounting for such diluents may reduce the effective operating range of the venturi or ejector 230.

The mixer area ratio (MAR) may need to be increased to protect for significant N₂ levels (e.g., about 4-8%), higher water content or humidity, and/or for high excess fuel ratios. The required entrainment ratio (ER) may be high because of significant contaminants and the mixer area ratio (MAR) may need to be increased correspondingly. For example, if the primary inlet pressure (P_{O}) is about 5.7 bara at maximum current flow rate with a primary inlet manifold pressure (P_{AIM}) of about 2.5 bara, the venturi or ejector 230 comprises a suction chamber with an efficiency of about 65% to about 50%, and the target entrainment ratio (ER) is about 2.1, the mixer area ratio (MAR) may be about 4.5 to about 5.7 for a pressure lift (ΔP_{LIFT}) range of about 5 kPa to 25 kPa.

The minimum mixer area ratio (MAR) under double choked conditions may be based on the highest temperature of the anode recirculation loop 224. In some embodiments, the fuel supply temperature (T_{CV}) may be pre-conditioned to extend the operating range of the venturi or ejector 230. The volume in the anode gas recirculation loop 224 may be large enough to enable the operation or usage of a further method that comprises high load purge and pressure management.

Primary nozzle 236 sizing methods may oversize the primary nozzle 236 to accommodate any instantaneous purge fuel flow rate. In some embodiments, the instantaneous purge flow rate may be about 10% of the maximum primary fuel flow rate. In other embodiments, the instantaneous purge flow rate may be more or less than about 10% of the maximum primary fuel flow rate. Oversizing the primary nozzle 236 for the instantaneous flow rate may result in a higher minimum operating current at which the venturi or ejector 230 may perform/operate effectively. For example, if the maximum current density the fuel cell system 10/11 operates at (i_{MAX}) is about 1.6 Amps/cm², then oversizing the primary nozzle 236 by 10% may increase minimum operating current density by about 0.16 A/cm².

A high load purge and pressure management method may be used/implemented to enable a reduced level of oversizing of the primary nozzle 236 while still accommodating the purge flow 286 requirements of the fuel cell system 10/11. The primary nozzle 236 may be oversized for the average purge flow rate, and not for the instantaneous purge flow rate. For example, the purge valve 284 may be open on average 20% of the time with 10% flow during purging. Thus, the average purge rate may be about 2% to about 3%, the primary nozzle 236 may be sized for this lower purge flow rate. When the primary nozzle 236 is sized for the average flow rate, the minimum operating current density of the fuel cell system 10/11 at which the venturi or ejector 230 can provide the target entrainment ratio (ER) without blower support may be reduced.

For example, if the average purge flow is 2%, the minimum operating current density may be about 0.13 Amps/cm² lower than the minimum operating when the primary nozzle 236 is sized for the instantaneous flow rate. The lower range may be about 0.40 A/cm² when the primary nozzle 236 is sized for the instantaneous flow rate and may be about 0.27 A/cm² when the primary nozzle 236 is sized for the average flow.

The high load purge and pressure management method may be is used for operating conditions where the flow rate of the primary flow 202 plus the instantaneous purge flow rate is less than the maximum flow rate of the primary flow 202. In some embodiments, the maximum flow rate or the primary flow 202 may account for the average purge flow rate. In other embodiments, the oversizing of the primary nozzle 236 may be required when purging is needed at the high operating current densities. For example, for a 10% purge flow 286, the high load purge and pressure management method would be needed when the fuel cell system 10/11 is operating at current densities equal and greater than about i_{MAX}/(1+0.1).

The high load purge and pressure management method may be a pro-active purge control strategy. In some embodiments, to reduce the amount of oversizing of the primary nozzle 236, a pro-active purge control strategy may be introduced during highest current density operating conditions. The pro-active purge control strategy may increase the primary mass flow rate 202 required to match the primary anode inlet manifold pressure (P_{AIM}) when anticipating a pressure decrease associated with a purging process. Thus, the target anode manifold pressure (P_{AIM}) may be increased to pro-actively prepare for the drop in pressure associated with an anticipated purge event. The required oversizing of the primary nozzle 236 while simultaneously minimizing the deviation from the target anode inlet manifold pressure (P_{AIM}) or the differential pressure between the cathode 208 and the anode 204.

The pro-active purge control strategy may require the ability to directly control the primary mass flow rate. In some embodiments, the pro-active purge control strategy may not be implemented with a mechanically regulated configuration as it may not have the required flexibility to control the primary mass flow rate. In other embodiments, the pro-active purge control strategy may be implemented with a proportional control valve.

In one embodiment, the purge valve 284 may be opened periodically for a short time. In some embodiments, the purge valve 284 may be able to open and close as efficiently and/or as quickly as required by the fuel cell system 10/11. In some embodiments, the purge valve 284 may take about 20-30 milliseconds (ms) to open or close. In other embodiments, the purge valve 284 may open or close in less than or more than about 20-30 ms.

In one embodiment, the purge valve 284 may be open for 0 seconds once every T seconds. In some embodiments, during this time period when the purge valve 284 is open, the purge flow 286 may be a nominal purge flow (m_{prg}) determined as:

m_{prg}=FR_{prg}×m_{H2_NOM}

FR_{prg} is the purge fraction and m_{H2_NOM} is the nominal flow rate of the primary flow 202 (e.g., of H₂ fuel) required to offset the fuel consumed in the fuel cell or fuel cell stack 12.

Without increasing the flow rate of the primary flow 202 above the nominal rate, the pressure of the anode side volume may decrease by a rate β bara/s when the purge valve 284 is open. The rate of decrease in the pressure of the anode side volume (β bara/s) depends on factors such as the effective purge volumetric flow rate, the anode side volume (V_{AN}), and/or the stack pressure (ΔP_{STACK}) If the stack pressure is (ΔP_{STACK}) is the primary anode inlet manifold pressure (P_{AIM}), the rate of decrease in the pressure of the anode side volume (β bara/s) is:

$$β = \frac{{FR}_{prg} \times {m}_{H 2 NOM}}{{ρ}_{AIM}} \times \frac{1}{{V}_{AN}} \times {P}_{AIM}$$

ρ_{AIM} is a representative density of the anode gas.

To offset any pressure drop, the average flow rate of the primary flow 202 may be increased above the nominal flow rate of the primary flow 202. For example, the average flow rate of the primary flow 202 may be increased by the fraction FR_{prg}×θ/T. The mass of fuel (e.g., H₂) in the primary flow 202 (m_{H2}) may be more than the nominal mass of fuel (e.g., H₂) in the primary flow 202 (m_{H2_NOM})

m_{H2_NOM}=m_{H2}(1+FR_{prg}×θ/T)

The rate of pressure may increase due to an excess average flow of the primary flow 202. The rate of pressure increase may be approximated as βθ/T. There may be a total anode side pressure differential (ΔP_{AN_DIFF}) between the end of one purge event and the start of the next purge event (Δt=T−θ). If the rate of pressure increase is as described, then the total increase in the pressure (ΔP_{AN_DEV_TOT}) may be approximated by:

ΔP_{AN_DEV_TOT}=βθ×(1−θ/T)

The pressure at the end of a purge event may be below the target pressure by about half of the total increase.

P_{AIM}(end of purge)=P_{AIM}−0.5×ΔP_{AN_DEV_TOT}

The change in pressure or the deviation from the target pressure (e.g., P_{AIM}) may be centered on the target pressure (e.g., P_{AIM}).

The ratio the time period the purge valve 284 is open (θ) to the duration between two openings of the purge valve 284 (T), i.e., θ/T, may be selected to ensure that the required purge is achieved by the fuel cell system 10/11. The fraction may be high enough to remove any diluent (e.g., water, cross-over gas, compound, element, mixture etc.) that may be accumulating and affecting the anode side volume (V_{AN}).

The duration between two openings of the purge valve 284 (T) may be chosen such that the opening rate of the valve may be sufficiently fast to achieve effective purging during the time period the purge valve 284 is open (θ). The duration between two openings of the purge valve 284 (T) may be as short as possible. The total increase in the pressure (ΔP_{AN_DEV_TOT}) may be maintained at an acceptable value.

An acceptable value of the duration between two openings of the purge valve 284 (T) may be determined by what could be tolerated by the fuel cell stack 12. For example, there may be an acceptable bias between the cathode and anode gases as described above. The acceptable value may need to ensure that there is never a negative bias such that the anode pressure is less than the cathode pressure. Preventing a negative bias may reduce crossover of contaminants. The acceptable value may need to limit the pressure difference between the anode and the cathode to avoid mechanical stress on the membrane electrode assembly (MEA) of the fuel cell stack. The acceptable value may range from about 5 kPa to about 50 kPa, including any pressure or range comprised therein.

The pro-active purge control strategy may be used continuously. The pro-active purge control strategy may be used if there arises a need for purging. Additionally, alternatively, the pro-active purge control strategy may be triggered intermittently. In some embodiments, a pro-active purge control strategy may be initiated ahead of a purge event. For example, a pro-active purge control strategy may be initiated if the need for a purge event is anticipated based on a sensed state, the pressure in the stack may be first increased by increasing the flow rate of the primary flow 202 above the flow rate required by the fuel cell or fuel cell stack 12 for a given period of time. Once a target pressure overshoot is reached, the purge event may be initiated. The excess flow rate of the primary flow 202 may be continued after the purge event to recover to the target anode inlet manifold pressure (PRIM).

In one embodiment, if the purge fraction (FR_{prg}) when the purge valve 284 is open is 0.1, the nominal anode inlet manifold pressure (P_{AIM_NOM}) is about 2.5 bara, the maximum increase in the pressure (ΔP_{AN_DEV_MAX}) is about 10 kPa, check units the nominal mass of fuel (e.g., H₂) in the primary flow 202 (m_{H2_NOM}) is about 3 gps, the anode side volume (V_{AN}) is about 4.7 L, and the average purging rate at a given current density is greater than 1/(1+FR_{prg}) (e.g., ˜0.02), anode inlet manifold density (ρ_{AIM}) is about 0.33 kg/m³, the ratio of the nominal mass of fuel (e.g., H₂) in the primary flow 202 to the anode inlet manifold density (m_{H2_NOM}/ρ_{AIM}) is about 9.1 L/s, the rate of decrease of the pressure of the anode side volume (β) is 48.4 kPa/s, the ratio of the time period the purge valve 284 is open to the duration between two openings of the purge valve (θ/T) is 0.2, the minimum time period the purge valve 284 is open (θ__{MIN}) is 0.006 s, the maximum time period the purge valve is open (θ__{MAX}) is given by:

θ__{MAX}=ΔP_{AN_DEV_MAX}/β/(1−θ/T)

θ__{MAX} is about 0.26 s, the maximum duration between two openings of the purge valve 284 (T_{MAX}) is 1.3 s, the rate of pressure increase is 9.7 kPa/s, and the time allowance of non-purging or time between two consecutive purges is 1.034 s.

The rate of pressure increase during non-purging may be minimized In some embodiments, the anode side volume (V_{AN}) may be increased and/or the nominal anode inlet manifold pressure (P_{AIM_NOM}) may be decreased. The fuel cell system 10/11 may need to account for other changes, boundary conditions, and/or operating limits when determining the purging rate, the time between consecutive purges, the time the purge vale is open for each purge, the rate of pressure increase, and/or the increase anode side volume.

The venturi or ejector 230 may be configured and/or designed to meet the requirements of operating the venturi or ejector 230 at or below a lowest current density such as the excess fuel ratio current density threshold (i__{λ_THV}) 150. If the venturi or ejector 230 is operating at or below a lowest current density such as the excess fuel ratio current density threshold (i__{λ_THV}) 150, the primary pressure needed to deliver the fuel may be below the critical pressure ratio (pr__{CR}). The primary mass flow 202 may be sensitive to downstream pressure (P_{S}) at the venturi or ejector 230 outlet at such low current densities and may be difficult to control.

The anode inlet manifold pressure (P_{AIM}), the operating temperature, and pressure losses in the fuel cell system 10/11 and/or in the anode gas recirculation loop 224 may be approximately constant at low current densities such as at and below the excess fuel ratio current density threshold (i__{λ_THV}) 150. The pressure lift (ΔP_{LIFT}) required is expected to be low and constant at low current densities such as at and below the excess fuel ratio current density threshold (i__{λ_THV}) 150.

c\Certain current densities such as the excess fuel ratio current density threshold (i__{λ_THV}) 150, or the low current ejector threshold (i__{LO_THV}) 460 or anode inlet manifold pressure (P_{AIM}) or pressure lift (ΔP_{LIFT}) or the target excess fuel ratio (λ__{TRGT}) may be used to determine the geometric parameters of the venturi or ejector 230. Certain range of geometric parameters may be used to design the venturi or ejector 230. The range of geometric parameters may be determined based on the excess fuel ratio current density threshold (i__{λ_THV}) 150, or the low current ejector threshold (i__{LO_THV}) 460 or operating pressure (e.g., anode inlet manifold pressure P_{AIM}) or pressure life (ΔP_{LIFT}) or the target excess fuel ratio (λ__{TRGT}).

The ability of the venturi or ejector 230 to deliver the required recirculation rate against the pressure life (ΔP_{LIFT}) may be enhanced by altering the geometrical configuration and/or design of the venturi or ejector 230. In other embodiments, the limitations associated with the venturi or ejector 230 may be considered in view of the fuel cell stack 12 requirements.

The geometric parameters of the venturi or ejector 230 may depend on the pressure lift (ΔP_{LIFT}) introduced by the fuel cell stack 12 in the fuel cell system 10/11. The geometric parameters of the venturi or ejector 230 may include considering the Mixer Area Ratio (MAR). A larger mixer area ratio allows for higher entrainment ratio (ER), but lowers the pressure lift (ΔP_{LIFT}) at the same primary flow 202 and outlet boundary conditions. The geometric parameters of the venturi or ejector 230 may evaluate the trade-offs in operating the venturi or ejector 230 based on operating curves and the optimal ranges for the variables affecting the said operation.

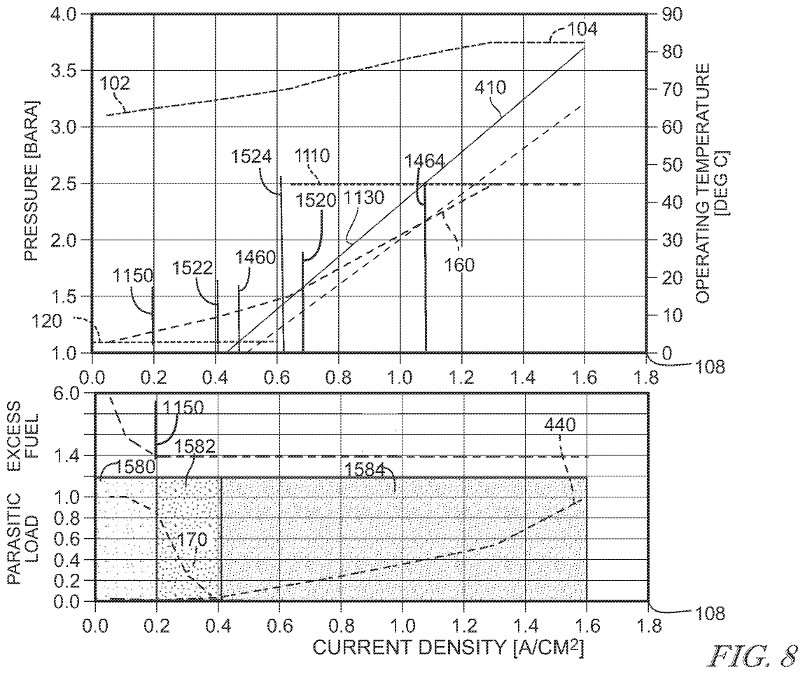

As shown in FIG. 8, the lowest current density at which the venturi or ejector 1230 is choked at steady state operating pressure (P__{AIM_SS}) is known as the lowest choked current density (i__{LO_ACT}) 1520. The system 10/11 may operate in a pseudo-steady state condition when the recirculation pump or blower 1220 is in an idle state, such as the idle state 484, i.e. the operating current density is greater than lowest choked current density (i__{LO_ACT}) 1520, or the blower is in a prime state i.e., the operating current density is much lower than the excess fuel ratio current density threshold (i__{λ_THV}) 1150, or the system 10/11 is boosted by the blower in a ejector support state 1582. The system 10/11 may be operating at a current density that is greater than the excess fuel ratio current density threshold (i__{λ_THV}) 1150 but less than lowest choked current density (i__{LO_ACT}) 1520 when it is in the ejector support state 1582. In some embodiments, the lowest choked current density (i__{LO_ACT}) 1520 may be equal to the critical current density (i__{LO_CR}) 1130.

In one embodiment, the system 10/11 may operate in a transient condition such as load shedding support state, where the target operating pressure (P_{AIM}) is greater than the steady state operating pressure (P__{AIM_SS}) such that the primary inlet nozzle is not choked. In other embodiments, the system 10/11 may operate in a transient condition such as load accepting support state, where the rate of increase in current density (i) is greater than a certain threshold such as 0.2 Amps/cm². In some embodiments, the system 10/11 may operate in a transient condition such system 10/11 startup or system 10/11 shutdown. In one embodiment, the recirculation pump or blower 1220 is sized such that the operation and/or performance of the venturi or ejector 1230 may be increased if required. In some embodiments, this increased capability of the venturi or ejector 1230 may impose higher cost and higher parasitic loads on the system 10/11.

In one embodiment, the recirculation pump or blower 1220 is sized to be able to at a minimum support the system 10/11 when the recirculation pump or blower 1220 is a prime state and during system 10/11 startup or system 10/11 shutdown states when the venturi or ejector 1230 cannot deliver the required fuel flow rates. In other embodiments, the recirculation pump or blower 1220 is sized to the differential pressure across the fuel cell stack 12 when the system 10/11 is under a transient condition such as load shedding support state.

In one embodiment, as shown in FIG. 8, the venturi or ejector 1230 may operate without ejector support at and above a blower threshold current density (i__{BS_THV}) 1522, the turn down ratio (TD_{RATIO}) that can be managed by the venturi or ejector 1230 when the system 10/11 is not choked is equal is:

TD_{RATIO}=i__{BS_THV}/i__{LO_ACT}

The lowest current density threshold at which the venturi or ejector 1230 is choked when the operating pressure (PAIN)) is the maximum operating pressure (P__{AIM_HI}) 1110 is the high current ejector threshold (i__{HI_THV}) 1464. In one embodiment, if a venturi or ejector 1230 needs to operate at the maximum operating pressure (P__{AIM_HI}) in a load shedding support state, then the venturi or ejector 1230 may drop below a current density equal to the high current ejector threshold (i__{HI_THv}) 1464. The venturi or ejector 1230 may not be choked at this current density. As this current density, the system 10/11 may need a recirculation pump or blower 1220 to provide blower support if the operating pressure (P_{AIM}) remains at the maximum operating pressure (P__{AIM_HI}) 1110. In some embodiments, for the same turndown ratio (TD_{RATIO}), recirculation pump or blower 1220 support may be needed starting at a current density equal to the transition blower threshold current density (i__{BS_TRNS_THV}) 1524. In other embodiments, the upper limit of the ejector support state 1582 is defined by the transition blower threshold current density (i__{BS_TRNS_THV}) 1524.

i__{BS_TRNS_THV}=i__{BS_THV}/i__{LO_ACT}×i__{HI_THV}

In one embodiment, if the venturi or ejector 1230 can operate without blower support at and above a blower threshold current (i__{BS_THV}) 1522 equal to the excess fuel ratio current density threshold (i__{λ_THV}) 1150,

i__{BS_TRNS_THV}=i__{λ_THV}/i__{LO_ACT}×i__{HI_THV}

A recirculation pump or blower 1220 is sized to provide flow under conditions where the venturi or ejector 1230 cannot provide all the fuel flow by itself. In one embodiment, during operation of the system 10/11 when support of the recirculation pump or blower 1220 is not needed, the recirculation pump or blower 1220 may act as a restriction and cause pressure loss in the anode recirculation loop 1224. The recirculation pump or blower 1220 may need to be oversized to support the venturi or ejector 1230 by decreasing the pressure lift (ΔP__{LIFT}) requirement under load shedding transient conditions when the system 10/11 is operating at a high primary anode inlet manifold pressure (e.g., (P__{AIM_HI}) 1110).

The recirculation pump or blower 1220 may be sized proportional to the blower threshold current density (i__{BS_THV}) 1522 and/or the transition blower threshold current density (i__{BS_TRNS_THV}) 1524. In other embodiments, the sizing of the recirculation pump or blower 1220 may not be linearly proportional to the blower threshold current density (i__{BS_THV}) 1522 and/or the transition blower threshold current density (i__{BS_TRNS_THV}) 1524. Alternatively, or additionally, the size of the recirculation pump or blower 1220 may depend on the mass flow rate through the recirculation pump or blower 1220.

The size of the recirculation pump or blower 1220 may depend on variables including but not limited to the entrainment ratio (ER) of the system 10/11, the excess fuel ratio (λ) of the system 10/11, the density of fuel composition flowing through the recirculation pump or blower 1220, the density of fuel composition flowing through the fuel cell or fuel cell stack 12, the anode inlet manifold pressure (P_{AIM}) of the system 10/11, the operating temperature of the system 10/11, the mass flow through the system 10/11, and/or the entrained flow through the recirculation pump or blower 1220.

A blower by-pass valve may be employed to lower the restriction imposed by the recirculation pump or blower 1220 when the system 10/11 is in a blower idle state 1584/484. A by-pass valve provides flexibility to avoid pressure losses due to the presence of a recirculation pump or blower 1220, and allows for robust interaction between the recirculation pump or blower 1220 and the venturi or ejector 1230.

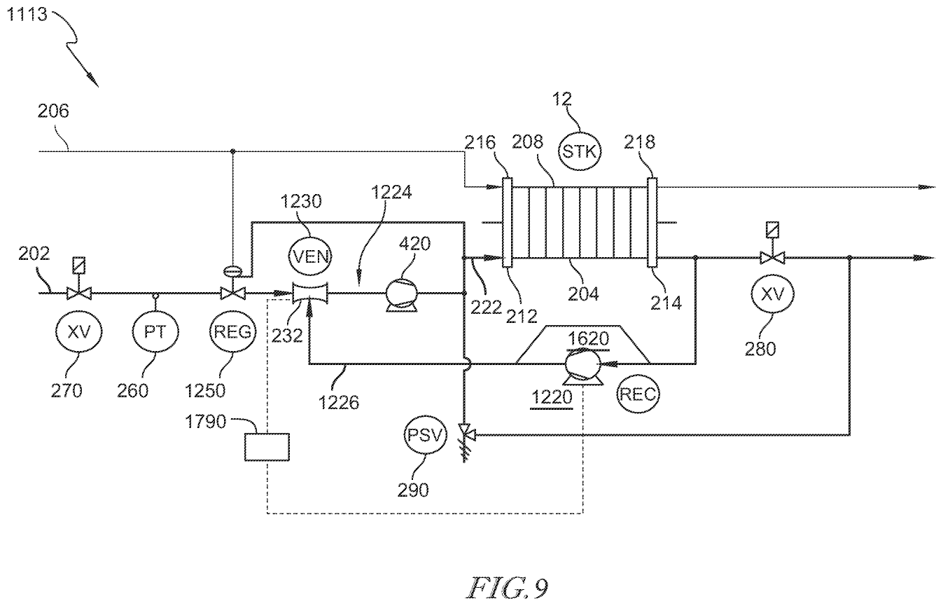

As illustrated in fuel cell system 1113 in FIG. 9, a by-pass valve 1620 may be located around the recirculation pump or blower 1220. In one embodiment, the by-pass valve 1620 may be electronically controlled, and/or mechanically controlled. In other embodiments, when the recirculation pump or blower 1220 cause a restriction under idle state conditions 1584/484, a by-pass valve 1620 may open.

The recirculation pump or blower 1220 in the system 1113 may be in an idle state 1584/484. The by-pass valve 1620 may be open when the recirculation pump or blower 1220 is in the idle state 1584/484. The recirculation pump or blower 1220 in the system 1113 may be in a prime state 1580/480. The by-pass valve 1620 may be fully closed when the recirculation pump or blower 1220 is in the prime state 1580/480. Alternatively, the recirculation pump or blower 1220 blower may be providing all of the recirculation flow 1226. The blower pressure (ΔP_{BLWR}) may adjust to provide sufficient recirculation flow fuel flow to match the fuel cell stack 12 excess fuel requirement in the system 1113.

The recirculation pump or blower 1220 in the system 1113 may be in a ejector support state 1582/482. The by-pass valve 1620 may be fully closed, fully open, or partially open, depending on the system 1113 need in the ejector support state 1582/482. The system 1113 may be in an ejector support state 1582/482 when transitioning from the blower prime state 480/1580 to the blower idle state 484/1584. The blower by-pass valve 1620 may be opened while the recirculation pump or blower 1220 is operating to smooth this transition.

The recirculation pump or blower 1220 may be configured or implemented to target a total recirculation volumetric flow rate. If the recirculation pump or blower 1220 cannot meet the required total recirculation volumetric flow rate, or if the recirculation pump or blower 1220 transiently cannot meet the required total recirculation volumetric flow rate, a by-pass valve 1620 may be opened to allow by-pass or recirculation flow.

The recirculation pump or blower 1220 may be in a blower idle state 1584/484 i.e. in a high load pseudo-steady state such that the current density is above the low current ejector threshold (i__{LO_THV}) 1460. When the system 10/11/1113 is operating at a current density above the low current ejector threshold (i__{LO_THV}) 1460, the venturi or ejector 1230 may be capable of delivering the required entrainment ratio (ER).

The venturi or ejector 1230 may have a robust entrainment ratio (ER) because of one or more controllers 1790 of the venturi or ejector 1230 and of the recirculation pump or blower 1220. One or more controllers 1790 of the venturi or ejector 1230 and the recirculation pump or blower 1220 may allow for the system 10/11/1113 to monitor the state of the venturi or ejector 1230 and start initiating and/or increasing speed of the recirculation pump or blower 1220 when support is needed.

In one embodiment, there may be a mismatch between the pressure provided by the recirculation pump or blower 1220 and the pressure needed by the venturi or ejector 1230 during recirculation pump or blower 1220 start up and/or shut down. In some embodiments, the by-pass valve 1620 may be used for a smooth transition during recirculation pump or blower 1220 start up and/or shut down.

In one embodiment, the by-pass valve 1620, the venturi or ejector 1230, and/or the recirculation pump or blower 1220 may be controlled by one or more controllers 1790 internal to the system 10/11/1113. In other embodiments, the by-pass valve 1620, the venturi or ejector 1230, and/or the recirculation pump or blower 1220 may be remotely monitored and/or controlled by one or more controllers 1790. In some embodiments, the one or more controller 1790 may be in communication with the fuel cell or fuel cell stack 12 in the system 10/11/1113, and/or the fuel management system in the fuel cell or fuel cell stack power module.

In one embodiment, the one or more controllers 1790 may measure/monitor the excess fuel ratio (λ) of the system 10/11/1113. In some embodiments, the one or more controllers 1790 may determine if the system 10/11/1113 is operating in a steady state (nominal) condition or a transient (non-nominal) condition. In some embodiments, the one or more controllers 1790 may determine the state of the recirculation pump or blower 1220 and/or the by-pass valve 1620 depending on the excess fuel ratio (λ) and/or operating state of the system 10/11/1113.

In one embodiment, the one or more controller 1790 for monitoring and/or controlling the operation of the proportional control valve 1310 or mechanical regulator 1250, by-pass valve 1620, the venturi or ejector 1230, and/or the recirculation pump or blower 1220 in a system 10/11/1113 may be implemented, in some cases, in communication with hardware, firmware, software, or any combination thereof present on or outside the in a system 10/11/1113 comprising the fuel cell or fuel cell stack 12. Information may be transferred to the one or more controllers 1790 using any one or more communication technology (e.g., wired or wireless communications) and associated protocols (e.g., Ethernet, InfiniBand®, Wi-Fi®, Bluetooth®, WiMAX, 3G, 4G LTE, 5G, etc.) to effect such communication.

The one or more controller 1790 may decipher, interpret, monitor, or read one or more sensors in the various components of the system 10/11/1113. The one or more controller 1790 may actuate a change in one or more components of the system 10/11/1113. In other embodiments, the one or more controller 1790 may control the function, operation, initiation, or stoppage of one or more components of the system 10/11/1113.

In one embodiment, as shown in FIG. 10, the one or more controller 1790 may be in a computing device 1710. The computing device 1710 may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The computing device 1710 may include an input/output (I/O) subsystem 1702, a memory 1704, a processor 1706, a data storage device 1708, a communication subsystem 1712, a controller 1790, and a display 1714. The computing device 1710 may include additional and/or alternative components, such as those commonly found in a computer (e.g., various input/output devices), in other embodiments. In other embodiments, one or more of the illustrative components may be incorporated in, or otherwise form a portion of, another component. For example, the memory 1704, or portions thereof, may be incorporated in the processor 1706.

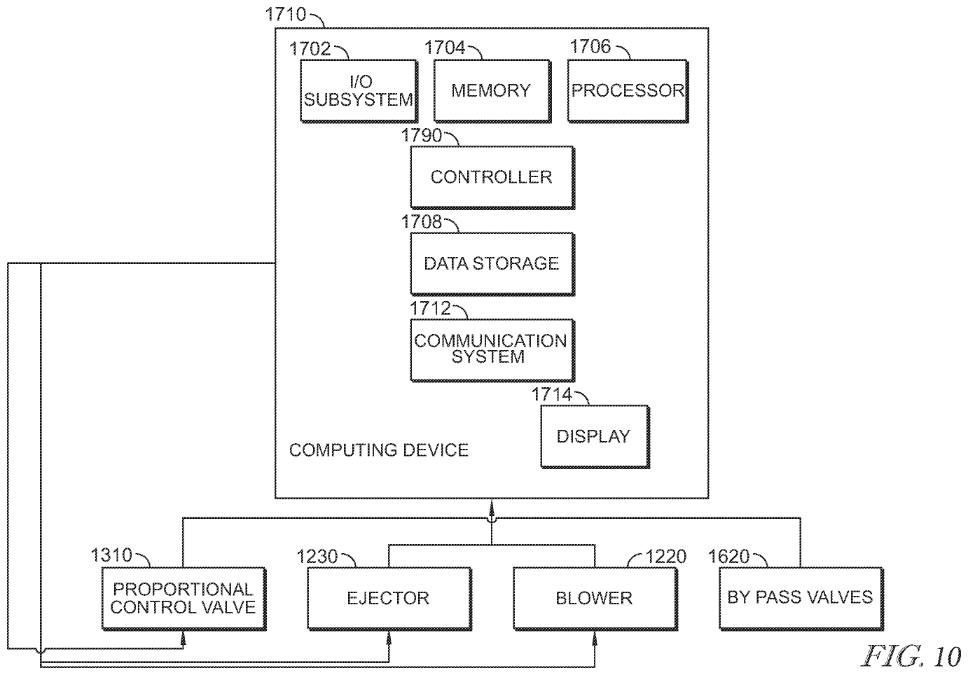

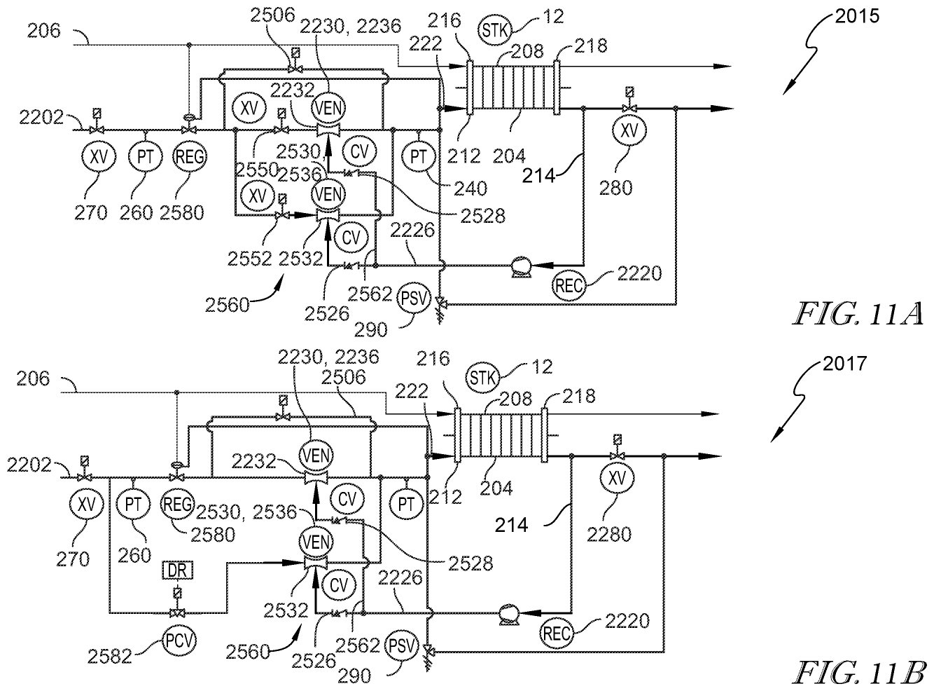

As shown in FIG. 11A and FIG. 11B, the fuel cell system 2015/2017 may have a second venturi or ejector 2530 (ejector 2) in a parallel configuration with the first venturi or ejector 2230 (ejector 1). In other embodiments, the fuel cell system 2015/2017 may have one or more venturi or ejectors 2530 in a parallel configuration with the first venturi or ejector 2230. In some embodiments, the fuel cell system 2015/2017 may have more than two to four venturi or ejectors 2530 in a parallel configuration with the first venturi or ejector 2230. In some other embodiments, the fuel cell system 2015/2017 may have more than four venturi or ejectors 2530 in a parallel configuration with the first venturi or ejector 2230.

In one embodiment, as shown in FIG. 11A and FIG. 11B, the fuel cell system 2015/2017 may have a control valve 2580 upstream of the venturi or ejector 2230/2530. In some embodiments, the control valve 2580 may be a mechanical regulator, a dome regulated mechanical regulator, a proportional control valve, or an injector.

The two or more venturi or ejector 2230/2530 may be of the same size. Alternatively, the two or more venturi or ejector 2230/2530 may be of different sizes. The two or more venturi or ejector 2230/2530 may be sized differently to retain the overall efficiency or performance of the two or more venturi or ejector 2230/2530. The size of a venturi or ejector 2230/2530 may include, but is not limited to measurements related to primary nozzle flow area, internal mixer area, mixer length, suction chamber design, diffuser expansion angle and diffusion expansion length.

The recirculation pump or blower 2220 may be a part of the fuel cell system 2015/2017. The recirculation pump or blower 2220 may be in a parallel or series configuration with the two or more venturi or ejectors 2230/2530. The recirculation pump or blower 220 may not be a part of the fuel cell system 2015/2017.

The fuel cell system 2015/2017 may have one or more by-pass valves. The by-pass valves may be located across one or more venturi or ejector 2230/2530. In one preferred embodiment, as shown in FIG. 11A and FIG. 11B, the fuel cell system 2015/2017 may have a by-pass valve 2506 downstream of the control valve 2580, around the venturi or ejector 2230. The fuel cell system 2015/2017 may also have an additional by-pass valve (not shown) around the venturi or ejector 2530. This configuration may not be preferred as it adds additional hardware to the fuel cell system 2015/2017. Alternatively, or additionally, fuel cell system 2015/2017 may have a by-pass valve 2506 upstream of the control valve 2580.

In one embodiment, as shown in FIG. 11A, the fuel cell system 2015/2017 may engage venturi or ejector 2230 or one or more venturi or ejector 2530, or both venturi or ejector 2230 and one or more venturi or ejector 2530. The transition from using one venturi or ejector 2230/2530 to using two or more ejectors 2230/2530 in the fuel cell system 2015 may not require more than one valve 2552. There may be some pressure losses in the fuel cell system 2015 associated with the secondary flow 2226.

The primary flow 2202 to the two or more venturi or ejector 2530/2230 may be regulated by one or more valves 2550/2552. The two or more valves 2550/2552 may be a proportional control valve or a mechanical regulator or a dome loaded mechanical regulator or an injector. In one embodiment, one of the two or more valves 2550/2552 may be a mechanical regulator. One of the two or more valves 2550/2552 may be a proportional control valve, a dome loaded mechanical regulator, or an injector.

Each of the two or more venturi or ejector 2230/2530 may have to work against the entire pressure lift of the fuel cell system 2015 (ΔP_{LIFT}), but each may be required to only lift the flow associated with the flow through primary nozzle 2236, 2536 of that respective venturi or ejector 2230/2530. The valves 2550/2552 regulating flow to the two or more venturi or ejector may 2530/2230 open and/or close to direct the primary flow 2202 to the two or more venturi or ejector 2530/2230. A part of the primary flow 2202 may flow through the first of the two or more venturi or ejector 2230/2530, and a part of the primary flow 2202 may flow through a second of the two or more venturi or ejector 2230/2530. The primary flow 2202 may be equally divided between the two or more venturi or ejector 2230/2530. The primary flow 202 may be unequally divided between the two or more venturi or ejector 2230/2530

A part of the secondary flow 2562 may enter the venturi or ejector 2230 at 2232 and a part the secondary flow 2560 may enter the one or more venturi or ejector 2530 at 2532. The secondary flow 2562 may not enter the venturi or ejector 2230 at 2232 and all of the secondary flow 2226 may enter the one or more venturi or ejector 2530 at 2532. The secondary flow 2560 may not enter the one or more venturi or ejector 2530 at 2532 and all of the secondary flow 2226 may enter the venturi or ejector 2230 at 2232. The secondary flow 2560/2562 through the venturi or ejector 2230/2530 may be regulated by check valves 2526/2528 that prevent reverse flow 25602/562.

In some embodiments, the fuel cell system 2015 may have two or more venturi or ejector 2230/2530, and may not have a recirculation pump or blower 2220. The check valves 2526/2528 that prevent reverse flow 2560/2562 may disconnect one of the two or more venturi or ejector 2230/2530 from the recirculation pump or blower 2220. The fuel cell system 2015 may achieve the target entrainment ratio (ER) without requiring a recirculation pump or blower 2220 and reducing parasitic loads. Alternatively, or additionally, the fuel cell system 2015 may achieve the target entrainment ratio (ER) by using a smaller recirculation pump or blower 2220 than what would have been required if the fuel cell system 2015 had only one venturi or ejector 2230. There may be some pressure losses in the fuel cell system 2015 associated with the secondary flow 2226, and or the one or more valves 2550/2552.

In one embodiment, as shown in FIG. 11B, the fuel cell system 2017 may include a control valve 2580 and an additional control valve 2582 instead of the open close valves 2550/2552 ahead of the two venture or ejectors 2230/2530. The additional control valve 2582 may be a mechanical regulator, a dome regulated mechanical regulator, a proportional control valve, or an injector. The control valve 2582 may be equipped to completely shut off flow to the venturi or ejector 2532. The control valves 2580 and 2582 may be the same or may be different. Such a configuration provides the fuel cell system 2017 with an additional flexibility in controlling pressure and/or primary fuel flow as it provides the system with two separate flow control valves, each independently controlling the primary flow 2202 into their respective venturi or ejectors 2230/2530.

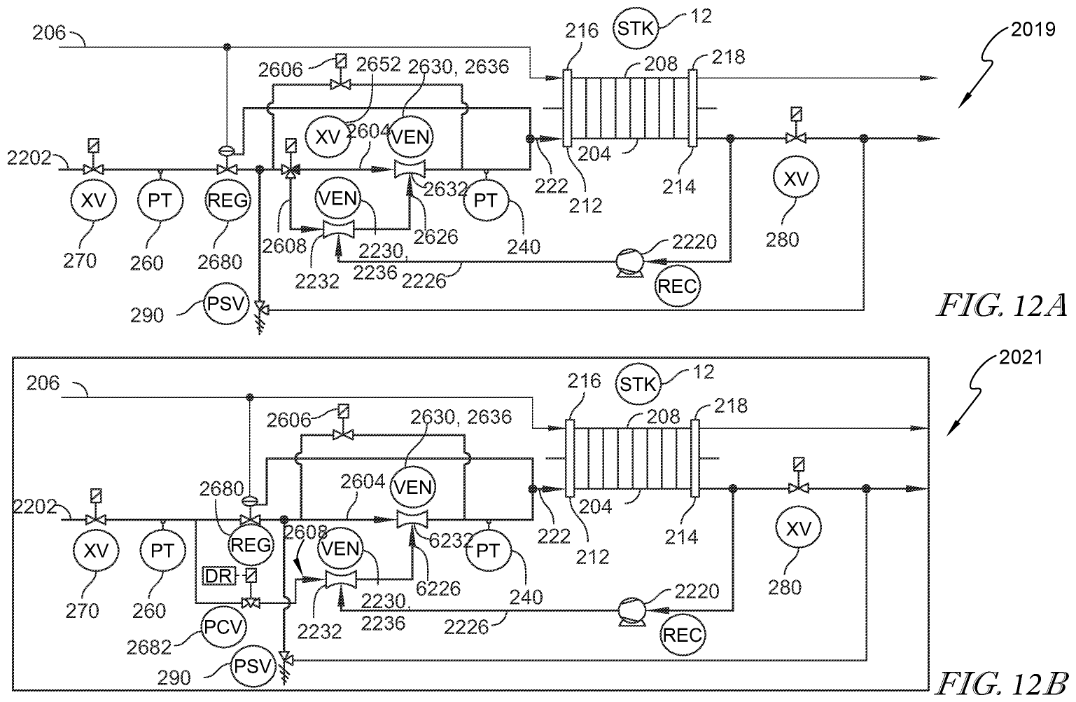

As shown in FIG. 12A and FIG. 12B, the fuel cell systems 2019/2021 may have a second venturi or ejector 2630 (ejector 2) in a series configuration with the first venturi or ejector 2230 (ejector 1). In other embodiments, fuel cell system 2019 may have one or more venturi or ejectors 2630 in a series configuration with the first venturi or ejector 2230. In some embodiments, the fuel cell system 2019 may have two to four venturi or ejectors 2630 in a series configuration with the first venturi or ejector 2230. In some other embodiments, the fuel cell system 2019 may have more than four venturi or ejectors 2630 in a series configuration with the first venturi or ejector 2230.

In one embodiment, as shown in FIG. 12A and FIG. 12B, the fuel cell system 2019/2021 may have a control valve 2680 upstream of the venturi or ejector 2230/2630. In some embodiments, the control valve 2680 may be a mechanical regulator, a dome regulated mechanical regulator, a proportional control valve, or an injector.

The two or more venturi or ejector 2230/2630 may be of the same size or of different sizes. The two or more venturi or ejector 2230/2530 may be sized differently to retain the overall efficiency or performance of the two or more venturi or ejector 2230/2530. The size of a venturi or ejector 2230/2530 may include, but is not limited to measurements related to primary nozzle flow area, internal mixer area, mixer length, suction chamber design, diffuser expansion angle and diffusion expansion length.

The recirculation pump or blower 2220 may be a part of the fuel cell system 2019/2021. The recirculation pump or blower 2220 may be in a parallel or series configuration with the two or more venturi or ejectors 2230/2630. In some embodiments, the recirculation pump or blower 2220 may not be a part of the fuel cell system 2019/2021.

The fuel cell system 2019/2021 may have one or more by-pass valves. In one preferred embodiment, as shown in FIG. 12A and FIG. 12B, the fuel cell system 2019/2021 may have a by-pass valve 2606 downstream of the control valve 2680, around the venturi or ejector 2630. Alternatively or additionally, the fuel cell system 2019/2021 may have an additional by-pass valve (not shown) around the venturi or ejector 2230. The fuel cell system 2019/2021 may have the by-pass valve 2606 upstream of the control valve 2680.

As shown in FIG. 12A, the primary flow 2202 to the two or more venturi or ejector 2630/2230 may be regulated by valve 2652. The valve 2652 may be a proportional control valve or a mechanical regulator or a dome loaded mechanical regulator or an injector. The primary flow 2202 to the two or more venturi or ejector 2630/2230 may be regulated by more than one valve 2652. The valve 2652 may regulate the primary flow 2202 entirely to the venturi or ejector 2230 or may regulate the primary flow 2202 entirely to the venturi or ejector 2630. Alternatively, the valve 2652 may regulate the primary flow 2202 to be divided between the venturi or ejector 2230 and one or more venturi or ejector 2630.

The fuel cell system 2019 may engage venturi or ejector 2230 (solo configuration) or one or more venturi or ejector 2630 (solo configuration), or both venturi or ejector 2230 and one or more venturi or ejector 2630 (dual configuration). The transition from using one venturi or ejector 2230/2630 to using two or more ejectors 2230/2630 may or may not require more than one valve 2652. There may be some pressure losses in the fuel cell system 2019 associated with the secondary flow 2226.

In one embodiment, as shown in FIG. 12B, the fuel cell system 2021 may include a control valve 2682 in addition to the control valve 2680 instead of the open close valves 2652 ahead of the two venturi or ejectors 2230/2630. The additional control valve 2682 may be a mechanical regulator, a dome regulated mechanical regulator, a proportional control valve, or an injector. The control valve 2682 may be equipped to completely shut off flow to the venturi or ejector 2632. The control valves 2680 and 2682 may be the same or may be different. Such a configuration provides the fuel cell system 2021 with an additional flexibility in controlling pressure and/or primary fuel flow as it provides the system with two separate flow control valves, each independently controlling the primary flow 2202 into their respective venturi or ejectors 2230/2630.

Each of the two or more venturi or ejector 2630 has to work against the entire pressure lift of the fuel cell system 2019 (ΔP_{LIFT}) if functioning in a solo configuration. Each of the two or more venturi or ejector 2630 may not have to work against the entire pressure lift of the fuel cell system 2019 (ΔP_{LIFT}) if functioning in a dual or multiple configuration.

In a series configurations as illustrated in FIGS. 12A and 12B, if both venturi or ejector 2230 and venturi or ejector 2630 are operational (i.e. in a dual configuration), each venturi or ejector 2230/2630 may need to lift the entire recirculation flow (secondary flow) 2226 through a fraction of pressure lift (ΔP_{LIFT}) in the fuel cell system 2019/2021. The secondary flow 226 may enter the venturi or ejector 2230 at 2232. The secondary flow 2626 entering the venturi or ejector 2630 at 2632 may comprise the secondary flow 2226 and the primary flow 2608 entering the venturi or ejector 2230. Additionally, the primary flow 2604 enters the venturi or ejector 2630. Thus, unlike a parallel configuration, the additional venturi or ejector 2630 may comprise an additional secondary flow because the venturi or ejector 2630 has to lift the primary flow 2608 from the venturi or ejector 2230.

The secondary flow properties of the venturi or ejector 2630 may be different from the secondary flow properties of the venturi or ejector 2230. The secondary flow 2626 through the venturi or ejector 2630 may be drier and/or have a higher fuel concentration (e.g., H₂) than the secondary flow 2226 through the venturi or ejector 2230. The secondary flow 2626 through the venturi or ejector 2630 may have different temperature than the secondary flow 2226 through the venturi or ejector 2230. The secondary flow 2626 through the venturi or ejector 2630 may have different density than the secondary flow 2226 through the venturi or ejector 2230.

The one or more venturi or ejector 2530/2630 in FIGS. 11A, 11B, 12A and 12B may be sensitive to the anode inlet manifold pressure (P_{AIM}) and/or the fuel supply pressure (P_{CV}) of the fuel cell system 2015/2017/2019/2021. The mixer area ratio (MAR) of the venturi or ejector 2230/2530 used in a parallel configuration is different than the mixer area ratio (MAR) of the venturi or ejector 2230/2630 used in a series configuration. In other embodiments, the mixer area ratio (MAR) of the venturi or ejector 2230/2530/2630 is sensitive to how the venturi or ejector 230/530/630 are configured in the fuel cell system 2015/2017/2019/2021.

The mixer area ratio (MAR) of the venturi or ejector in a series configuration 2630 may need be larger than the mixer area ratio (MAR) of the venturi or ejector in a parallel configuration 2530. If all else is equal, the mixer area ratio (MAR) of the venturi or ejector 2230/2530/2630 may be a critical parameter that influences entrainment ratio (ER) vs pressure lift (ΔP_{LIFT}) capability of the fuel cell system 2015/2017/2019/2021. A larger mixer area ratio (MAR) enables a larger entrainment ratio (ER), but lower pressure lift (ΔP_{LIFT}) capability at the same primary nozzle flow 2202.

Sizing of the more than one venturi or ejector 2230/2530 in a parallel configuration or the more than one venturi or ejector 2230/2630 in a series configuration is critical for determining the entrainment ratio (ER) vs pressure lift (ΔP_{LIFT}) capability of the fuel cell system 2015/2017/2019/2021. In some embodiments, the factors affecting primary nozzle sizing are similar in parallel (FIGS. 11A and 11B) and series configuration (FIGS. 12A and 12B). In other embodiments, the sizing of other geometric parameters may vary between the parallel (FIGS. 11A and 11B) and series configuration (FIGS. 12A and 12B).

The ratio of the primary nozzle of the venturi or ejector 2230 (ejector 1) to the primary nozzle of the venturi or ejector 2530/2630 (ejector 2) may be equal to the ratio of the inlet diameter of the primary nozzle of the venturi or ejector 2230 (ejector 1) to the inlet diameter of the of the primary nozzle of the venturi or ejector 2530/2630 (ejector 2). In some embodiments, the ratio of the primary nozzle of the venturi or ejector 2230 (ejector 1) to the primary nozzle of the venturi or ejector 2530/2630 (ejector 2) may be equal to the ratio of the inlet area of the primary nozzle of the venturi or ejector 2230 (ejector 1) to the inlet area of the of the primary nozzle venturi or ejector 2530/2630 (ejector 2). In some other embodiments, the ratio of the primary nozzle of the venturi or ejector 2230 (ejector 1) to the primary nozzle of the venturi or ejector 2530/2630 (ejector 2) may be equal to the ratio of the outlet diameter of the of the primary nozzle of the venturi or ejector 2230 (ejector 1) to the outlet diameter of the of the primary nozzle of the venturi or ejector 2530/2630 (ejector 2).

The more than one venturi or ejector 2230/2530 in a parallel configuration or the more than one venturi or ejector 2230/2630 in a series configuration may be sized according to the minimum fuel supply pressure (P__{CV_MIN}) for both venturi or ejectors (2230 and 2530 or 2230 and 2630). In some embodiments, the venturi or ejector 2230 (ejector 1) may be sized to cover half the range of the venturi or ejector 2530/2630 (ejector 2).

The relative sizing of the venturi or ejector 2230 (ejector 1) and venturi or ejector 2530/2630 (ejector 2) may depend on the turn down ratio of the venturi or ejectors (2230 and 2530 or 2230 and 2630). The turn down ratio ejector 2230 (ejector 1) and venturi or ejector 2530/2630 (ejector 2) may be the same, or may be different from each other.

For example, in one embodiment, if the turn down ratio of both venturi or ejectors (2230 and 2530 or 2230 and 2630) is 2, the venturi or ejector 2530/2630 (ejector 1) may be sized to cover the range of about 16.7% to about 33.3% of the primary flow, and the venturi or ejector 2530/2630 (ejector 2) may be sized to provide about 33.3% to about 66.7% of the primary flow. Together, venturi or ejector 2230 (ejector 1) and venturi or ejector 2530/2630 (ejector 2) may be sized to cover the range of about 66.7% to about 100% of primary flow. In other embodiments, if the turn down ratio of both venturi or ejectors (2230 and 2530 or 2230 and 2630) is 3, the venturi or ejector 2530/2630 (ejector 1) may be sized to cover the range of about 8.33% to about 25% of the primary flow, and the venturi or ejector 2530/2630 (ejector 2) may be sized to provide about 25% to about 75% of the primary flow. Together, venturi or ejector 2230 (ejector 1) and venturi or ejector 2530/2630 (ejector 2) may be sized to cover the range of about 50% to about 100% of primary flow. In some other embodiments, if the turn down ratio of both venturi or ejectors (2230 and 2530 or 2230 and 2630) is 1.5, the venturi or ejector 2530/2630 (ejector 1) may be sized to cover the range of about 26.6% to about 40% of the primary flow, and the venturi or ejector 2530/2630 (ejector 2) may be sized to provide about 40% to about 60% of the primary flow. Together, venturi or ejector 2230 (ejector 1) and venturi or ejector 2530/2630 (ejector 2) may be sized to cover the range of about 60% to about 100% of primary flow.

In one embodiment, the venturi or ejector 2230 (ejector 1) may have a turn down ratio in the range from about 1.5 to about 8, including any ratio or range of ratio comprised therein. In some embodiments, the venturi or ejector 2530/2630 (ejector 2) may have a turn down ratio in the range from about 1.5 to about 8, including any ratio or range of ratio comprised therein. In some embodiments, the venturi or ejector 2230 (ejector 1) and/or the venturi or ejector 2530/2630 (ejector 2) may be sized according to their turn down ratios. For example, if the turn down ratio of both venturi or ejectors (2230 and 2530 or 2230 and 2630) is 8, the venturi or ejector 2530/2630 (ejector 1) may be sized to cover the range of about 1.4% to about 11.1% of the primary flow, and the venturi or ejector 2530/2630 (ejector 2) may be sized to provide about 11.1% to about 89% of the primary flow.

The sizing of the venturi or ejectors may depends on the number of venturi or ejectors in the fuel cell system 2015/2017/2019/2021. The venturi or ejector 2230 (ejector 1) and the venturi or ejector 2530/2630 (ejector 2) may be sized to cover different ratios of the operating range of the fuel cell system 2015/2017/2019/2021.

In one embodiment, the fuel cell system 2015/2017/2019/2021 may have a by-pass valve 2506/2606 configured to account for the entrainment ratio (ER) at higher operating ranges such as above about 0.4 Amps/cm², or above about 0.6 Amps/cm², or above about 0.8 Amps/cm², or above about 1.0 Amps/cm², or above about 1.2 Amps/cm². The by-pass valve 2506/2606 may be configured to account for the entrainment ratio (ER) at operating ranges up to the highest operating range of the fuel cell system 2015/2017/2019/2021.

The venturi or ejector 2230 (ejector 1) and the venturi or ejector 2530/2630 (ejector 2) may be sized to account for the entrainment ratio (ER) at operating ranges below the operating range accounted for by the by-pass valve 2506/2606. For example, the venturi or ejector 2230 (ejector 1) and the venturi or ejector 2530/2630 (ejector 2) may be sized such that both the venturi or ejector 2230 (ejector 1) and the venturi or ejector 2530/2630 (ejector 2) can together account for the entrainment ratio (ER) at operating ranges below about 0.4 Amps/cm², or below about 0.6 Amps/cm², or below about 0.8 Amps/cm², or below about 1.0 Amps/cm², or below about 1.2 Amps/cm².

The venturi or ejector 2230 (ejector 1) may be sized to cover half the range of the venturi or ejector 2530/2630 (ejector 2), such that both the venturi or ejector 2230 (ejector 1) and the venturi or ejector 2530/2630 (ejector 2) can together account for the entrainment ratio (ER) at operating ranges below the operating range accounted for by the by-pass valve 2506/2606. For example, the venturi or ejector 2230 (ejector 1) may be sized to cover half the range of the venturi or ejector 2530/2630 (ejector 2), such that both the venturi or ejector 2230 (ejector 1) and the venturi or ejector 2530/2630 (ejector 2) can together account for the entrainment ratio (ER) at operating ranges below about 0.4 Amps/cm², or below about 0.6 Amps/cm², or below about 0.8 Amps/cm², or below about 1.0 Amps/cm², or below about 1.2 Amps/cm². In other embodiments, the venturi or ejector 2230 (ejector 1) and the venturi or ejector 2530/2630 (ejector 2) may be sized to cover different ratios of the operating range below the operating range accounted for by the by-pass valve 2506/2606.

The venturi or ejector 2230 (ejector 1) receiving the secondary flow 2226 may be sized to provide the full secondary flow 2226 requirement at the lowest target operating current i.e. the excess fuel ratio current density threshold (i k THV) 2150. In some embodiments, the lowest target operating current may be different from the excess fuel ratio current density threshold.

The fuel cell system 2015/2017/2019/2021 may have a by-pass valve 2506/2606 configured to account for the entrainment ratio (ER) at higher operating ranges such as above about 0.4 Amps/cm², or above about 0.6 Amps/cm², or above about 0.8 Amps/cm², or above about 1.0 Amps/cm², or above about 1.2 Amps/cm². The venturi or ejector 2230 (ejector 1) receiving the secondary flow 2226 may be sized to provide the full secondary flow 2226 requirement at the lowest target operating current i.e. the excess fuel ratio current density threshold (i__{λ_THV}) 2150, and the venturi or ejector 2530/2630 (ejector 2) may be sized to account the operating range above the operating range accounted for by the venturi or ejector 2230 (ejector 1) and below the operating range accounted for by the by-pass valve 2506/2606.

At the lowest target operating current threshold (i__{λ_THV}) 2150, the primary nozzle inlet pressure (P_{O_i_λ_THV}) is:

P_{O}_i__{λ_THV}=P_{AIM}_i__{λ_THV}×pr_CR

P_{AIM}_i__{λ_THV} is the anode inlet manifold pressure at the lowest target operating current threshold (i__{λ_THV}). The critical pressure (pr__{CR}) is ˜1.9 bara for H₂.

The primary nozzle 2236, 2536, 2636 may be sized to meet maximum primary flow, including the purge flow. The primary nozzle inlet pressure in the primary nozzle sized to meet maximum primary flow, including the purge flow at the lowest target operating current threshold (i__{λ_THV}) 2150 (P_{O_CV_THV}) is:

P_{O_CV_THV}=P_{O}_i__{λ_THV}×i_{MAX_P}/i__{λ_THV}

The fuel supply pressure threshold (P__{CV_THV}) is:

P__{CV_THV}=P_{O_CV_THV}×P__{CR}

The maximum current (i_{MAX}) accounting for the purge flow is the maximum current with purge (i_{MAX_P}), given by:

i_{MAX_P}=i_{MAX}(1+prg)

The fraction of purge flow is given by prg.

When the fuel supply pressure (P_{CV}) is greater than the fuel supply pressure threshold (P__{CV_THV}), the venturi or ejector 2230 (ejector 1) may provide almost 100% of the primary and recirculated flow in the fuel cell system 2019/2021. The mixer area ratio (MAR) and other parameters may be sized to enable the required entrainment ratio to be maintained across the entire operating range. If the lowest target operating current (i__{λ_THV}) is 0.2 Amps/cm², the critical pressure (pr__{CR}) is 1.9 bara, and the anode inlet manifold pressure at the lowest target operating current P_{AIM} (i__{λ_THV}) is 1.2 bara, the primary inlet nozzle pressure at the lowest target operating current (P_{O}(i__{λ_THV}) is 2.28 bara. If the maximum current (i_{MAX}) is 1.6 Amps/cm², and the purge flow is 10%, the primary inlet nozzle pressure at fuel supply pressure threshold (P_{O_CV_THV}) is 20.1 bara and the fuel supply pressure threshold (P__{CV_THV}) is 38.1 bara.

The venturi or ejector 2530/2630 (ejector 2) may be sized to enable full primary flow requirement to be met at the fuel supply pressure threshold (P__{CV_THV}). The total effective flow area of the primary nozzles of a venturi or ejector 2530/2630 may be based on the maximum current at purge (i_{MAX_P}) and the fuel sizing pressure (P__{CV_MIN}). The effective flow area of the primary nozzle of the venturi or ejector 2630 (ejector 2) i.e. A_{EFF_EJCT2} is:

A_{EFF_EJCT2}=A__{EFF_TOT}−A_{EFF_EJCT1}

A_{EFF_EJCT1} is the effective flow area of the primary nozzle of the venturi or ejector 2230 (ejector 1), and A__{EFF_TOT} is the total effective flow area of the primary nozzle of the venturi or ejector 2230/2630.

If the fuel sizing pressure or the minimum control valve inlet pressure (P__{CV_MIN}) is about 14 bara, the fraction of purge flow (prg) is 10%, P_{O}_i__{λ_THV} is the minimum primary inlet nozzle pressure needed at the lowest target operating current threshold (i__{λ_THV}) P_{O_P}_i__{λ_THV} is the minimum primary inlet nozzle pressure needed for purge flow at the lowest target operating current threshold (i__{λ_THV}) 2150, i_{MAX} is the maximum current of the fuel cell system 2015/2017/2019/2021 i_{MAX_P} is maximum current of the fuel cell system 2015/2017/2019/2021 accounting for purge flow, venturi or ejector 2230 (ejector 1) and venturi or ejector 2530/2630 (ejector 2) may be sized as shown below in Table 1.

TABLE 1

| | P_{O}_{_{—}}_{P}_i_{_{—}}_{λ}_{_{—}}_{THV} | A_{EFF} | i_{MAX}_{_{—}}_{P} | i_{MAX} | P_{O}_i_{_{—}}_{λ}_{_{—}}_{THV} |
|---|---|---|---|---|---|
| Ejector 1 | 7.37 | 1.66 | 0.65 | 0.59 | 6.70 |
| Total | | 4.49 | 1.76 | 1.60 | |
| Ejector 2 | | 2.83 | 1.11 | 1.01 | |

In one embodiment, the fuel cell system 2015/2017/2019/2021 may be configured to ensure division of labor between the venturi or ejector 2230 (ejector 1) and the venturi or ejector 2630/2530 (ejector 2) such that the required entrainment ratio (ER) may be delivered. In some embodiments, the pressure operating curves of the fuel cell system 2015/2017/2019/2021 may influence the division and labor and the switching between solo use (ejector 1 or ejector 2) and dual use. In some embodiments, the mixer area ratio (MAR) and other parameters of the venturi or ejector 2230/2530/2630 may be sized in view of the intended operation of the fuel cell system 2015/2017/2019/2021. In some embodiments, the intended operation may determine if the configuration of the venturi or ejector 2230/2530/2630 are in series or in parallel, or if ejector 1 2230 is required to operate cross the entire operating range.

The ejector 1 maximum current (i__{MAX_01}) is the maximum current that ejector 1 2230 can support on its own at a given fuel supply pressure (P_{CV}) and primary inlet temperature (T_{O}). The ejector 2 maximum current (i__{MAX_02}) is the maximum current that ejector 2 2530/2630 can support on its own at a given fuel supply pressure (P_{CV}) and primary inlet temperature (T_{O}). The ejector 1 minimum current (i__{MIN_01}) is the minimum current that ejector 1 2230 can support to keep ejector 1 2230 choked. The ejector 2 minimum current (i_{MIN_02}) is the minimum current that ejector 2 2530/2630 can support to keep ejector 2 2530/2630 choked. The total minimum current (i__{MIN}) is:

i__{MIN}=i__{MIN_01}+i__{MIN_02}

If the current demand (i__{DEMAND}) is less than the lower of the ejector 1 minimum current (i__{MIN_01}) and the ejector 2 minimum current (i__{MIN_02}), primary flow 2202 may go through ejector 1 2230 and the fuel cell system 2015/2017/2019/2021 may operate the recirculation pump or blower 2220 to meet the required entrainment ratio (ER). In some embodiments, the primary flow 2202 may or may not go through ejector 2 2530/2630.

If the ejector 1 maximum current (i__{MAX_01}) is greater than the maximum current in the fuel cell system 2015/2017/2019/2021 (i_{MAX}) 2134, then the ejector 1 may be operated solely for any current demand (i__{DEMAND}). In some embodiments, the ejector 1 2230 may be operated solely for any current demand (i__{DEMAND}) if

P_{CV}/√T_{O}>P__{CV_THV}/√T_{O_MAX}

T_{O_MAX} is the maximum primary inlet temperature of the fuel cell system 2015/2017/2019/2021.

If the ejector 1 maximum current (i__{MAX_01}) is lesser than the maximum current in the fuel cell system 2015/2017/2019/2021 (i_{MAX}) 2134, then the primary flow 2202 may be split between ejector 1 2230 and ejector 2 2530/2630. In some embodiments, as the current demand (i__{DEMAND}) increases, the fuel cell system 2015/2017/2019/2021 may transition from a solo configuration using ejector 1 2230 to a solo configuration using ejector 2 2530/2630. In other embodiments, as the current demand (i__{DEMAND}) increases, the fuel cell system 2015/2017/2019/2021 may transition from a solo configuration using ejector 1 2230 or solo configuration using ejector 2 2530/2630 to a dual configuration using ejector 1 2230 and ejector 2 2530/2630.

In one embodiment, the fuel cell system 2015/2017/2019/2021 may not transition from using ejector 1 2230 to using ejector 2 2530/2630 until the current in the fuel cell system 2015/2017/2019/2021 reaches the ejector 2 minimum current (i__{MIN_02}). In some embodiments, the fuel cell system 2015/2017/2019/2021 may not transition away from being a solo configuration using ejector 1 2230 before the current in the fuel cell system 2015/2017/2019/2021 reaches the ejector 1 maximum current (i__{MAX_01}). In other embodiments, the fuel cell system 2015/2017/2019/2021 may not transition from a solo configuration to a dual configuration until the total minimum current (i__{MIN}) is reached. In some other embodiments, the fuel cell system 2015/2017/2019/2021 may transition from a solo configuration to a dual configuration before the ejector 2 maximum current (i__{MAX_02}) is reached.

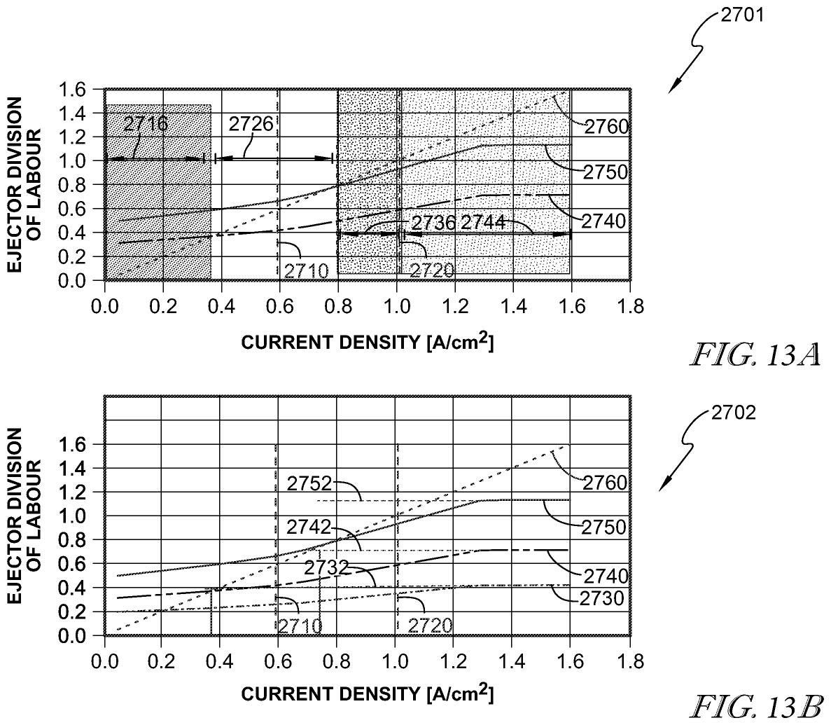

In one embodiment, as shown in the graph 2701 in FIG. 13A, if the fuel supply pressure (P_{CV}) is equal to the minimum control valve inlet pressure (P__{CV_MIN}), at about 14 bara, the ejector 1 maximum current (i__{MAX_01}) 2710 may be about 0.6 Amps/cm², and the ejector 2 maximum current (i__{MAX_02}) 2720 may be about 1 Amps/cm². In some embodiments, fuel cell system 2015/2017/2019/2021 may operate in a solo configuration using ejector 1 2230 at a current demand (i__{DEMAND}) when the ejector 2 minimum current (i__{MIN_02}) 2740 is greater than the curve 2760 and when the current demand (i DEMAND) is lower than the ejector 1 maximum current (i__{MAX_01}) 2710 (region 2716).

In other embodiments, the fuel cell system 2015/2017/2019/2021 may operate in a solo configuration using ejector 2 2530/2630 at a current demand (i__{DEMAND}) when the ejector 2 minimum current (i__{MIN_02}) 2740 is lower than the curve 2760 and the total minimum current total (i_MIN) 2750 is greater than the curve 2760 (region 2726).

In one embodiment, the fuel cell system 2015/2017/2019/2021 may operate in a dual configuration using ejector 1 2230 and ejector 2 2530/2630 at a current demand (i__{DEMAND}) that is greater than the ejector 1 maximum current (i__{MAX_01}) 2710 and lower than the ejector 2 maximum current (i__{MAX_02}) 2720 and when the total minimum current total (i__{MIN}) 2750 is lower than the curve 2760 (region 2736). In some other embodiments, the fuel cell system 2015/2017/2019/2021 may be required to operate in a dual configuration using ejector 1 2230 and ejector 2 2530/2630 at a current demand (i DEMAND) that is greater than the ejector 2 maximum current (i__{MAX_02}) 2720 (region 2744). In some embodiments, if the total minimum current (i__{MIN}) 2750 is less than the curve 2760, the nozzles may be choked when both ejector 1 2230 and ejector 2 2530/2630 are enabled. In some other embodiments, if the ejector 2 minimum current (i__{MIN_02}) 2740 is lower than the curve 2760, the nozzles may be choked when the fuel cell system 2015/2017/2019/2021 is in a solo configuration using ejector 2 2530/2630.

In one embodiment, during transient states or conditions such as load shedding state, the fuel cell system 2015/2017/2019/2021 may need to be able to deliver a primary fuel flow different from steady state conditions. In some embodiments, during a transient state or condition, the primary anode inlet manifold pressure (P_{AIM}) may be temporarily higher than the nominal value (steady state value) at a given current density demand (i__{DEmAND}). In other embodiments, the maximum current that may be supported by ejector 1 2230 and/or ejector 2 2530/2630 may not be affected. For example, ejector 1 2230, ejector 2 2530/2630 may be sized for maximum anode inlet pressure (P__{AIM_HI}). In some embodiments, the minimum current that may be supported by ejector 1 2230 and/or ejector 2 2530/2630 may be affected.

In one embodiment, as shown in the graph 2702 in FIG. 13B, the maximum anode inlet pressure (P__{AIM_HI}) may be extended for lower current densities as indicated by the curves 2732, 2742, 2752. These extensions presume the maximum anode inlet pressure (P__{AIM_HI}) can be extended to lower operating points.

In one embodiment, the fuel supply pressure (P_{CV}) may be equal to the fuel supply threshold pressure (P__{CV_THV}) (e.g., about 14 bara). In some embodiments, the fuel cell system 2015/2017/2019/2021 may operate at a current demand (i__{DEMAND}) greater than about 1.3 Amps/cm² and then decrease to a lower current demand (i__{DEMAND}). In other embodiments, if the current demand (i__{DEMAND}) is greater than about 1.15 Amps/cm², the fuel cell system 2015/2017/2019/2021 may be in a dual configuration. In some embodiments, the fuel cell system 2015/2017/2019/2021 may have some gaps. For example, when i__{DEMAND} is between about 1.0 Amps/cm² and about 1.15 Amps/cm², or when current demand (i__{DEMAND}) between about 0.6 Amps/cm² and about 0.7 Amps/cm², or when i__{DEMAND} is lower than about 0.4 Amps/cm², the system may not be able to optimize division of labor between the ejectors 2230/2530/2630.

In one embodiment, if the current demand (i__{DEMAND}) greater is between about 0.7 Amps/cm² and about 1.0 Amps/cm², the fuel cell system 2015/2017/2019/2021 may be in a solo configuration using ejector 2 2530/2630. The fuel cell system 2015/2017/2019/2021 may be in a solo configuration using ejector 2 2530/2630 for current demand (i DEMAND) between where the ejector 2 minimum current (i__{MIN_02}) 2740 extension 2742 intersects with the curve 2760 and where the ejector 2 minimum current (i__{MIN_02}) 2740 extension 2742 the ejector 2 maximum current (i__{MAX_02}) 2720.

In one embodiment, if the current demand (i__{DEMAND}) is between about 0.4 Amps/cm² and about 0.6 Amps/cm², the fuel cell system 2015/2017/2019/2021 may be in a solo configuration using ejector 1 2230. The fuel cell system 2015/2017/2019/2021 may be in a solo configuration using ejector 1 2230 for a current demand (i__{DEMAND}) in the range between where the ejector 1 minimum current (i__{MIN_01}) 2730 extension 2732 intersects with the curve 2760 and where the ejector 1 minimum current (i__{MIN_01}) 2730 extension 2732 intersects the ejector 1 maximum current (i__{MAX_01}) 2710.

In one embodiment, gaps may exist, where the fuel cell system 2015/2017/2019/2021 may not be able to support the current demand (i__{DEMAND}). In some embodiments, the gaps may be when the current demand (i__{DEMAND}) is between about 1.0 Amps/cm² and about 1.15 Amps/cm², or when the current demand (i DEMAND) is between about 0.6 Amps/cm² and about 0.7 Amps/cm², or when the current demand (i DEMAND) is less than about 0.4 Amps/cm².

In one embodiment, the ejector 1 maximum current (i__{MAX_01}) 2710 and/or the ejector 2 maximum current (i__{MAX_02}) 2720 may be influenced by fuel supply pressure state (P__{CV_ST}). In some embodiments, if the fuel supply pressure (P_{CV}) is increased from about 14 bara to about 20 bara, the fuel cell system 2015/2017/2019/2021 may be able to overcome all gaps except for when the current demand (i__{DEMAND}) is lower than about 0.4 Amps/cm². For example, when the current demand (i__{DEMAND}) is greater than about 1.15 Amps/cm², the fuel cell system 2015/2017/2019/2021 may operate in a dual configuration. When the current demand (i__{DEMAND}) is between about 0.7 Amps/cm² and about 1.15 Amps/cm², the fuel cell system 2015/2017/2019/2021 may operate in a solo configuration using ejector 2 2530/2630. When the current demand (i__{DEMAND}) is between about 0.4 Amps/cm² and about 0.6 Amps/cm², the fuel cell system 2015/2017/2019/2021 may operate in a solo configuration using ejector 1 2230. In some embodiments, the system may be able to provide sufficient entrainment ratio by operating ejector 1 2230 and/or ejector 2 2530/2630 in different configurations.

In one embodiment, during transient states or conditions, the fuel cell system 2015/2017/2019/2021 may monitor the primary anode inlet manifold pressure (P_{AIM}) and adjust the transition points between ejector 1 2230 and ejector 2 2530/2630 based on the primary anode inlet manifold pressure (P_{AIM}) Aligned with the methods described above. In one embodiment, during transient states or conditions, the fuel cell system 2015/2017/2019/2021 may monitor the fuel supply pressure (P_{CV}).

In one embodiment, the fuel cell system 2015/2017/2019/2021 may operate in a transient state or condition such as load shedding state, start-up state, or shut down state. In some embodiments, the fuel cell system 2015/2017/2019/2021 may operate in a transient lag state such that the pressure or temperature of the fuel cell 20 or fuel cell stack 12 may be lagging the pressure or temperature fuel cell 20 or fuel cell stack 12 in the transient state or condition. For example, in some embodiments, during transient state or condition, the fuel cell system 2015/2017/2019/2021 may be in a transient lag state where the system is able to support the required current density of the transient state or conditions, but the fuel cell 20 or fuel cell stack 12 operating temperature may take time to decrease.

In one embodiment, when the fuel cell system 2015/2017/2019/2021 is in the transient lag state, the fuel cell system 2015/2017/2019/2021 may enter a zone or a gap as referred to earlier, where the venturi or ejector 2230/2530/2630 along with the recirculation pump or blower 2220 are not able to support the required current density. In some embodiments, the one or more controllers of the venturi or ejector 2230/2530/2630 and of the recirculation pump or blower 2220 may choose to operate the fuel cell system 2015/2017/2019/2021 at a current density higher than the required current density so that the fuel cell system 2015/2017/2019/2021 produces more energy than required.

In one embodiment, the system may comprise one or more one or more integrated controllers in the ejectors 2230/2530/2630 to monitor the primary anode inlet manifold pressure (P_{AIM}) and/or the fuel supply pressure (P_{CV}) in the fuel cell system 2015/2017/2019/2021. In other embodiments, the one or more controllers of the venturi or ejector 2230 and of the recirculation pump or blower 2220 may choose to operate the fuel cell system 2015/2017/2019/2021 at a current density lower than the required current density so that the fuel cell system 2015/2017/2019/2021 produces less energy than required.

In one embodiment, the one or more controllers in the ejectors 2230/2530/2630 may communicate with one or more controllers in an energy storage device in the fuel cell system 2015/2017/2019/2021. In some embodiments, the one or more controllers in the ejectors 2230/2530/2630 may control the energy storage device. In one embodiment, the energy storage device may be a battery. In other embodiments, the energy storage device may be a supercapacitors, superconductors, via Li-ion batteries, lead-acid batteries, flywheels, compressed air, or phase change materials.

In one embodiment, the energy storage device in the fuel cell system 2015/2017/2019/2021 may provide power during the gaps mentioned earlier and enable the fuel cell system 2015/2017/2019/2021 to attain the required entrainment ratio (ER). In some other embodiments, the one or more controllers of the energy storage device may determine if energy can be stored or used from the energy storage device.

In one embodiment, the one or more controllers of the energy storage device may determine if sufficient energy is stored in the energy storage device such that the primary anode inlet manifold pressure (P_{AIM}) during the transient state or transient lag state may be able to reach the nominal the primary anode inlet manifold pressure (P_{AIM}) during steady state conditions by using some or all of the available energy.

In one embodiment, the fuel cell system 2015/2017/2019/2021 may have need the support of the recirculation pump or blower 2220 to achieve the required entrainment ratio (ER). In some embodiments, recirculation pump or blower 2220 may have one or more controllers integrated with the one or more controllers in ejectors 2230/2530/2630 and/or the one or more controllers in the energy storage device in the fuel cell system 2015/2017/2019/2021. In other embodiments, one or more controllers in the ejectors 2223/2530/2630, the energy storage device, and/or in the recirculation pump or blower 2220 may enable robust transition of the fuel cell system 2015/2017/2019/2021 from a solo configuration using ejector 1, 2230 to a solo configuration using ejector 2, 2530/2630 and back. In some other embodiments, one or more controllers in the ejectors 2230/2530/2630, the energy storage device, and/or in the recirculation pump or blower 2220 may enable robust transition of the fuel cell system 2015/2017/2019/2021 from a solo configuration using ejector 1, 2230 to a dual configuration and/or from a solo configuration using ejector 2, 2530/2630 to a dual configuration.

In one embodiment, the ejectors 2230/2530/2630, the energy storage device, and/or the recirculation pump or blower 2220 may be controlled by one or more controllers internal to the fuel cell system 2015/2017/2019/2021. In other embodiments, the ejectors 2230/2530/2630, the energy storage device, and/or the recirculation pump or blower 2220 may be remotely monitored and/or controlled by one or more controllers.

In one embodiment, the one or more controller for monitoring and/or controlling the operation of the ejectors 2230/2530/2630, the energy storage device, and/or the recirculation pump or blower 2220 may in a fuel cell system 2015/2017/2019/2021 may be implemented, in some cases, in communication with hardware, firmware, software, or any combination thereof present on or outside the in a fuel cell system 2015/2017/2019/2021 comprising the fuel cell 20 or fuel cell stack 12. Information may be transferred to the one or more controllers using any one or more communication technology (e.g., wired or wireless communications) and associated protocols (e.g., Ethernet, InfiniBand®, Wi-Fi®, Bluetooth®, WiMAX, 3G, 4G LTE, 5G, etc.) to effect such communication.

In one embodiment, the one or more controllers may be in a computing device. The computing device may be embodied as any type of computation or computer device capable of performing the functions described herein, including, but not limited to, a server (e.g., stand-alone, rack-mounted, blade, etc.), a network appliance (e.g., physical or virtual), a high-performance computing device, a web appliance, a distributed computing system, a computer, a processor-based system, a multiprocessor system, a smartphone, a tablet computer, a laptop computer, a notebook computer, and a mobile computing device.

The computing device may include an input/output (I/O) subsystem, a memory, a processor, a data storage device, a communication subsystem, a controller, and a display. The computing device may include additional and/or alternative components, such as those commonly found in a computer (e.g., various input/output devices), in other embodiments. In other embodiments, one or more of the illustrative components may be incorporated in, or otherwise form a portion of, another component. For example, the memory, or portions thereof, may be incorporated in the processor.

The following described aspects of the present invention are contemplated and non-limiting:

A first aspect of the present invention relates to a fuel cell or fuel cell system. The fuel cell or fuel cell system includes an ejector, a first fuel, and a second fuel. The ejector includes a primary nozzle, a mixer, a mixer entrance, a mixer inlet area, a mixer length, a mixer diameter, a mixer outlet area, a diffuser, and a diffuser outlet area. The primary nozzle includes a primary nozzle throat diameter, a primary nozzle inlet area, and a primary nozzle throat area. The first fuel is from a fuel supply that flows through the primary nozzle into the mixer. The second fuel flows through an anode recirculation loop which includes a secondary suction chamber into the mixer. The ejector is sized based on a lower current density operating point or a highest current density operating point of the fuel cell system.

A second aspect of the present invention relates to a method of purging and managing pressure in a fuel cell system. The method includes the steps of flowing a first fuel at a first mass flow rate from a fuel supply through a primary nozzle into a mixer region, flowing a second fuel through an anode recirculation loop including a secondary suction chamber into the mixer region, mixing the first fuel and the second fuel to form a mixture in a mixer including a diffuser, flowing the mixture through a fuel cell stack, purging a part of the mixture through a purge valve, and managing pressure of an anode side volume of the fuel cell stack system during purging. The fuel supply includes a fuel supply pressure and a fuel supply temperature. The ejector includes a mixer area ratio (MAR) and a mixer length ratio (MLR). The primary nozzle is sized based on the fuel supply pressure, the fuel supply temperature, and a highest fuel flow rate required by the fuel cell system.

In the first aspect of the present invention, the ejector may include a mixer area ratio (MAR) sized for the highest current density operating point. The MAR may allow about 2 to about 20 times the amount of the second fuel to enter the ejector at the lowest current density operating point compared to the amount of the second fuel that enters the ejector at the highest current density operating point. In the first aspect of the present invention, the MAR may be optimized to allow a required entrainment ratio at the highest current density operating point.

In the first aspect of the present invention, the ejector may include other geometry parameters optimized at the lowest current density operating point. The other geometry parameters may be a ratio of the mixer length to the mixer diameter (MLR), a diffuser diverging angle, or a ratio of the diffuser outlet area to the mixer outlet area (DAM). In the first aspect of the present invention, the ratio of the mixer length to the mixer diameter (MLR) may be from about 3 to about 7. In the first aspect of the present invention, the ratio of the diffuser outlet area to the mixer outlet area (DAM) may be from about 1.9 to about 7.3. In the first aspect of the present invention, the diffuser diverging angle may be from about 6° to about 18°.

In the first aspect of the present invention, the mixer area ratio (MAR) of the ejector may allow a minimum target excess fuel ratio (λ__{TRGT}) to be achieved at the highest operating current density of the system.

In the first aspect of the present invention, the suction chamber may include a nozzle to mixer inlet distance (N2M) and a converging angle at mixer inlet (α_{ES}) that minimizes losses through the suction chamber at the highest current density operating point. In the first aspect of the present invention, the nozzle to mixer inlet distance (N2M) may be optimized at the lowest current density operating point. The ratio of the nozzle to mixer inlet distance (N2M) to the primary nozzle throat diameter may be about 0 to about 5.

In the first aspect of the present invention, the velocity of the second fuel may include a Mach number below about 0.2 at the exit plane of the primary nozzle.

In the first aspect of the present invention, the ejector may include a geometric configuration optimized to operate at the lowest current density and the highest current density.

In the first aspect of the present invention, the fuel cell system may include a purge valve and the primary nozzle may be sized based on a purge flow required by the fuel cell system. In the first aspect of the present invention, the primary nozzle may be sized based on a maximum instantaneous purge at the highest current density.

In the first aspect of the present invention, the system may include a mixer area a mixer area ratio (MAR) of about 4 to about 5.2 for a primary inlet pressure (P_{O}) of about 5.7 bara at a maximum current flow rate with a primary inlet manifold pressure (P_{AIM}) of about 2.5 bara, a target entrainment ratio (ER) of about 1.6, a suction chamber efficiency of about 65% to about 50%, and a pressure lift (ΔP_{LIFT}) of about 5 kPa to 25 kPa. In the first aspect of the present invention, if the system includes a contaminant level of about 4% to about 8% in the anode recirculation loop, the mixer area ratio (MAR) may be about 4.5 to about 5.7.

In the second aspect of the present invention, the purge valve may be opened for 0 seconds periodically every T seconds. θ/T may be high enough to remove any contaminants accumulating in the system.

In the second aspect of the present invention, pressure of the anode side volume of the fuel cell system may be decreased at a rate (β) based on purge volumetric flow rate, the anode side volume, and stack pressure.

In the second aspect of the present invention, managing pressure of anode side volume of the fuel cell system during purging may include increasing the first mass flow rate of the first fuel to offset any decrease in the pressure of the anode side volume of the fuel cell system.

A first aspect of the present invention relates to a system for monitoring or controlling operation of a fuel cell system. The system includes a first fuel entering an ejector, a second fuel entering a blower or the ejector, and a controller that communicates with the blower or the ejector to monitor or control flow of the first fuel or the second fuel in the fuel cell system. The ejector has a primary inlet pressure and a secondary inlet pressure.

A second aspect of the present invention relates to a method for monitoring or controlling operation of a fuel cell system. The method includes the steps of flowing a first fuel into an ejector, flowing a second fuel into a blower or the ejector, communicating with the blower or the ejector through a controller, and monitoring or controlling flow of the first fuel or flow of the second fuel in the fuel cell system. The ejector has a primary inlet pressure and a secondary inlet pressure.

In the first or second aspect of the present invention, the fuel cell system may operate and/or the method may include operating the fuel cell system in a system operating state including a steady state or a transient state. The fuel cell system may include a target excess fuel ratio or an anode gas inlet humidity. In the first and second aspect of the present invention, the blower may operate and/or the method may further include the blower operating in a blower operating state including idle state, ejector support state, or prime state. The controller may determine the blower operating state. In the first and second aspect of the present invention, a by-pass valve may be positioned across the blower to allow the second fuel to flow around the blower. The by-pass valve may be included in the fuel cell system. In the first and second aspect of the present invention, the controller may communicate with and/or the method may include the controller communicating with the by-pass valve positioned across the blower. In the first and second aspect of the present invention, the controller may determine and/or the method may further include the controller determining the blower operating state. In the first and second aspect of the present invention, the controller may determine and/or the method may further include the controller determining a pressure drop at the system operating state, a pressure lift that can be delivered by the ejector, and may determine if the pressure drop is greater or lesser than the pressure lift that can be delivered by the ejector.

In the first and second aspect of the present invention, if the pressure drop is less than the pressure lift that can be delivered by the ejector, the blower may operate in the idle state and/or the method may include the controller operating the blower in the idle state. In the first and second aspect of the present invention, if the pressure drop is less than the pressure lift that can be delivered by the ejector, the by-pass valve positioned across the blower may be opened and/or the method may further include opening the by-pass valve positioned across the blower. In the first and second aspect of the present invention, if the pressure drop is more than the pressure lift that can be delivered by the ejector, the blower may operate in the ejector support state and/or the method may further include operating the blower in the ejector support state.

In the first and second aspect of the present invention, the controller may determine and/or the method may further include the controller determining a blower operating state based on a target entrainment ratio of the fuel cell system, efficiency of the blower, choked or unchoked condition of the ejector, or transient or steady state of the fuel cell system.

A first aspect of the present invention relates to a fuel system. The fuel cell system includes a first ejector, a second ejector, an energy storage device, and an integrated controller. The integrated controller communicates with the energy storage device, the first ejector, and the second ejectors. The first ejector includes a first primary fuel, a first entrained fuel, a first maximum current density, and a first minimum current density. The second ejector includes a second primary fuel, a second entrained fuel, a second maximum current density, and a second minimum current density. The fuel cell system operates in a transient lag state.

A second aspect of the present invention relates to a method of operating a fuel cell system. The method includes the steps of flowing a first primary fuel through a control valve and through a first ejector, flowing a first entrained fuel through the first ejector, flowing a second primary fuel through the control valve and through a second ejector, flowing a second entrained fuel through the second ejector, and operating the first ejector or the second ejector in a transient lag state.

In the first aspect of the present invention, the fuel cell system may further include a blower in a series or parallel configuration with the first ejector or with the second ejector.

In the first aspect of the present invention, the first ejector may be in a parallel configuration or in a series configuration with the second ejector. In the first aspect of the present invention, the fuel cell system may transition between operating a solo configuration and operating in a dual configuration based on operating pressure. Operating in the solo configuration may include operating the first ejector or the second ejector, while operating in the dual configuration includes operating the first ejector and the second ejector. In the first aspect of the present invention, the fuel cell system may transition between operating in a solo configuration and operating in a dual configuration based on storage capacity of the energy storage device. Operating in the solo configuration may include operating the first ejector or the second ejector, while operating in the dual configuration may include operating the first ejector and the second ejector. In the first aspect of the present invention, the integrated controller may determine a sufficient energy available in the energy storage device such that an anode pressure during transient lag state reaches a nominal anode pressure.

In the first aspect of the present invention, the fuel cell system may include a required entrainment ratio. The energy storage device may power the fuel cell system to achieve the required entrainment ratio if the first ejector or the second ejector cannot provide the required entrainment ratio.

In the first aspect of the present invention, the energy storage device may be a battery. In the first aspect of the present invention, the energy storage device may include a supercapacitor, a superconductor, a flywheel, compressed air, or a phase change material.

In the first aspect of the present invention, the fuel cell system may include a third ejector in a series or in a parallel configuration with the first ejector or with the second ejector.

In the second aspect of the present invention, the first ejector may be in a parallel configuration or in a series configuration with the second ejector. In the second aspect of the present invention, the method may further include using an energy storage device. In the second aspect of the present invention, operating the fuel cell system may include transitioning between operating in a solo configuration including the first ejector or the second ejector and operating in a dual configuration including the first ejector and the second ejector. This transitioning may be based on a storage capacity of the energy storage device. In the second aspect of the present invention, using the energy storage device may include using an integrated controller that communicates with the energy storage device, the first ejector, and the second ejector. In the second aspect of the present invention, the method may include the integrated controller determining a sufficient storage in the energy storage device such that an anode pressure of the fuel cell system during transient lag state reaches a nominal anode pressure. In the second aspect of the present invention, the fuel cell system may transition between operating in a solo configuration including the first ejector or the second ejector and a dual configuration including the first ejector and the second ejector. This transitioning may be based on an operating pressure during transient lag state.

In the second aspect of the present invention, the fuel cell system may include a required entrainment ratio. The method may include the energy storage device powering the fuel cell system to achieve the required entrainment ratio if the first ejector or the second ejector cannot provide the required entrainment ratio.

In the second aspect of the present invention, the energy storage device may be a battery.

In the second aspect of the present invention, the fuel cell system may include a third ejector in a series or in a parallel configuration with the first ejector or with the second ejector.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third,” and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell or fuel cell system comprising:
an ejector including a primary nozzle, a mixer, a mixer entrance, a mixer inlet area, a mixer length, a mixer diameter, a mixer outlet area, a diffuser, and a diffuser outlet area, the primary nozzle including a primary nozzle throat diameter, a primary nozzle inlet area and a primary nozzle throat area,
a first fuel from a fuel supply that flows through the primary nozzle into the mixer, and
a second fuel that flows through an anode recirculation loop including a secondary suction chamber into the mixer,
wherein the ejector is sized based on a lowest current density operating point or a highest current density operating point of the fuel cell system.

2. The system of claim 1, wherein the ejector comprises a mixer area ratio (MAR) sized for the highest current density operating point, and wherein the MAR allows about 2 to about 20 times the amount of the second fuel to enter the ejector at the lowest current density operating point compared to the amount of the second fuel that enters the ejector at the highest current density operating point.

3. The system of claim 2, wherein the MAR is optimized to allow a required entrainment ratio at the highest current density operating point.

4. The system of claim 1, wherein the ejector comprises other geometry parameters optimized at the lowest current density operating point, and wherein the other geometry parameters are a ratio of the mixer length to the mixer diameter (MLR), a diffuser diverging angle, or a ratio of the diffuser outlet area to the mixer outlet area (DAM).

5. The system of claim 4, wherein the ratio of the mixer length to the mixer diameter (MLR) is from about 3 to about 7.

6. The system of claim 4, wherein the ratio of the diffuser outlet area to the mixer outlet area (DAM) is from about 1.9 to about 7.3.

7. The system of claim 4, wherein the diffuser diverging angle is from about 6° to about 18°.

8. The system of claim 1, wherein the mixer area ratio (MAR) of the ejector allows a minimum target excess fuel ratio (λ__{TRGT}) to be achieved at the highest operating current density of the system.

9. The system of claim 1, wherein the suction chamber comprises a nozzle to mixer inlet distance (N2M) and a converging angle at mixer inlet (a E s) that minimizes losses through the suction chamber at the highest current density operating point.

10. The system of claim 10, wherein the nozzle to mixer inlet distance (N2M) is optimized at the lowest current density operating point, and wherein the ratio of the nozzle to mixer inlet distance (N2M) to the primary nozzle throat diameter is about 0 to about 5.

11. The system of claim 1, wherein the velocity of the second fuel comprises a Mach number below about 0.2 at the exit plane of the primary nozzle.

12. The system of claim 1, wherein the ejector comprises a geometric configuration optimized to operate at the lowest current density and the highest current density.

13. The system of claim 1, wherein the fuel cell system comprises a purge valve and the primary nozzle is sized based on a purge flow required by the fuel cell system.

14. The system of claim 13, wherein the primary nozzle is sized based on a maximum instantaneous purge at the highest current density.

15. The system of claim 1, wherein the system comprises a mixer area ratio (MAR) of about 4 to about 5.2 for a primary inlet pressure (P_{O}) of about 5.7 bara at a maximum current flow rate with a primary inlet manifold pressure (P ABA) of about 2.5 bara, a target entrainment ratio (ER) of about 1.6, a suction chamber efficiency of about 65% to about 50%, and a pressure lift (ΔP_{LIFT}) of about 5 kPa to 25 kPa.

16. The system of claim 15, wherein if the system comprises a contaminant level of about 4% to about 8% in the anode recirculation loop, the mixer area ratio (MAR) is about 4.5 to about 5.7.

17. A method of purging and managing pressure in a fuel cell system comprising:
flowing a first fuel at a first mass flow rate from a fuel supply through a primary nozzle into a mixer region,
flowing a second fuel through an anode recirculation loop including a secondary suction chamber into the mixer region,
mixing the first fuel and the second fuel to form a mixture in a mixer including a diffuser,
flowing the mixture through a fuel cell stack,
purging a part of the mixture through a purge valve, and
managing pressure of an anode side volume of the fuel cell stack system during purging,
wherein the fuel supply comprises a fuel supply pressure and a fuel supply temperature, and the ejector comprises a mixer area ratio (MAR) and a mixer length ratio (MLR),
wherein the primary nozzle is sized based on the fuel supply pressure, the fuel supply temperature, and a highest fuel flow rate required by the fuel cell system.

18. The method of claim 17, wherein the purge valve is opened for 0 seconds periodically every T seconds, and wherein err is high enough to remove any contaminants accumulating in the system.

19. The method of claim 17, wherein pressure of the anode side volume of the fuel cell system is decreased at a rate (β) based on purge volumetric flow rate, the anode side volume, and stack pressure.

20. The method of claim 17, wherein managing pressure of anode side volume of the fuel cell system during purging comprises increasing the first mass flow rate of the first fuel to offset any decrease in the pressure of the anode side volume of the fuel cell system.
